(19) United States
(12) Patent Application Publication
(10) Pub. No.: US 2026/0148093 A1
(43) Pub. Date: May 28, 2026

(54) MACHINE-LEARNING SYSTEMS AND METHODS FOR PREDICTING ENTITY OPERATION AND GENERATING ENTITY AND/OR SYSTEM ALTERATIONS

(71) Applicant: Optum, Inc., Minnetonka, MN (US)

(72) Inventors: Rahul AGGARWAL, Bengaluru (IN); Ankit KINDRA, Delhi (IN); Pulkit AGARWAL, Delhi (IN); Vikrant ARORA, Davao (PH)

(21) Appl. No.: 18/956,497

(22) Filed: Nov. 22, 2024

(51) Int. Cl. G06N 5/01

(52) U.S. Cl. CPC G06N 5/01

(57) ABSTRACT

Systems and methods are disclosed for processing multidimensional data using machine-learning models to classify an entity, predict metrics, and/or generate transcripts. The method includes receiving multi-dimensional data that include a first value of a first dimension indicating a comparison of an entity with a group of entities, and a second value of a second dimension indicating an attribute of the entity irrespective of the group of entities; inputting the multi-dimensional data to a first machine-learning model to output a prediction value determined based on applying first and second weights to the first and second values, respectively; and upon determining the prediction value satisfies first threshold associated with an adverse event: filtering historical text data associated with the entity to exclude data that satisfies second threshold associated with acceptable operations; and generating, by inputting the filtered historical text data into a second machine-learning model, a transcript of recommended actions.

### TECHNICAL FIELD

This present disclosure relates generally to a machine-learning architecture and use thereof for predicting future operational state degradation across a system and generating instructions to alter one or more factors detected by the machine-learning architecture as contributing to the predicted degradation.

### BACKGROUND

Conventional methodologies for improving entity operations (e.g., call center operations) are hindered due to their inherent technical limitations. These methodologies typically rely on manual review and historical data analysis which fail to provide real-time insights necessary for proactive entity adjustments. The data collected is often siloed across different systems, leading to fragmented views and an incomplete understanding of overall performance. Furthermore, these methods are predominantly rule-based and lack the sophistication to adapt to complex and evolving entity operations. This rigidity prevents the detection of emerging trends and the identification of root causes behind performance issues.

### BRIEF DESCRIPTION OF THE DRAWINGS

The accompanying drawings, which are incorporated in and constitute a part of this specification, illustrate various example embodiments and together with the description, serve to explain the principles of the disclosed embodiments.

FIG. 1 illustrates a block diagram of an example system for processing multidimensional data using one or more machine-learning models to classify an entity as a target/non-target, predict metrics associated with the entity, and/or generate a transcript of one or more recommended actions, according to aspects of the disclosure.

FIG. 2 illustrates a flowchart of an example process for generating a risk score indicating a predicted likelihood that an entity is or will become a target entity in the future and generating entity-specific recommendations based on multidimensional data and using machine-learning models, according to aspects of the disclosure.

FIG. 3A illustrates an example process for predicting target entities and providing entity-specific instructions generated by a machine-learning model to improve performance, according to aspects of the disclosure.

FIG. 3B illustrates an example process of detecting target entities and determining an impact of instructions generated by a machine-learning model, according to aspects of the disclosure.

FIG. 3C illustrates an example graph of a Gain measure for validating a machine-learning model and an example table that compares the machine-learning model's effectiveness in detecting target entities against conventional methods demonstrating a higher gain in detecting target entities, according to aspects of the disclosure.

FIG. 4A illustrates example historical entity performance metrics used to generate an entity risk score for an entity ultimately classified by the techniques discussed herein as a target entity and entity performance metrics determined after the entity risk score was generated and verifying that the classification as a target entity was correct, according to aspects of the disclosure.

FIG. 4B illustrates example historical entity performance metrics used to generate an entity risk score for an entity ultimately classified by the techniques discussed herein as a non-target entity and entity performance metrics determined after the entity risk score was generated and verifying that the classification as a non-target entity was correct, according to aspects of the disclosure.

FIG. 4C illustrates an example entity interface generated and/or pre-populated based at least in part on output received from a machine-learning model, according to aspects of the disclosure.

FIG. 5 illustrates a flowchart of an example process for training a machine-learning model.

FIG. 6 illustrates a block diagram of an example implementation of a computer system that executes at least a portion of the techniques presented herein.

### DETAILED DESCRIPTION OF EMBODIMENTS

This disclosure relates to a machine-learning architecture configured for predicting operational state degradation within a system, and autonomously generating corrective instructions for an entity, associated with the system, to adjust factor(s) contributing to the predicted degradation. In some embodiments, the entity may be an internal user of the system, such as an employee, call center agent, or other suitable user having access to resources of the system. In some embodiments, the entity may interact with external user(s) of the system, such as a customer, and such interactions may be evaluated by the system to determine the entity's performance. In particular, a machine-learning model associated with the system, trained on historical data associated with specific entities, may calculate a dynamic risk score that quantifies the probability of performance degradation over a defined future period or by a specified future time. This architecture leverages these predictions to proactively generate entity-specific instructions (e.g., that if adopted by the entity may improve the entity's future performance), by modifying the variable(s) detected as contributing to the predicted performance degradation, improving long-term performance and stability across the system.

Current methodologies face significant technical challenges while predicting the operational state of an entity and/or computing device(s) associated with the entity. For instance, data needed for predicting the operational state are not holistic and often siloed across disparate systems, leading to fragmented views and incomplete understanding of overall entity performance. The data is often one dimensional in the sense that only narrowly defined performance-based data are utilized, and therefore does not include other types of data that are not considered performance-based data but nevertheless contribute to entity performance. Moreover, traditional methods depend heavily on linear models and basic statistical analysis, which are insufficient for predicting future trends, detecting potential issues, and generating feedback for the entity that is understandable to the user and actionable.

Additionally, existing approaches involve time-consuming and error-prone manual processes for data integration and analysis, further diminishing their effectiveness. Scalability issues arise as these conventional methods are not designed to handle (e.g., filter) the increasing volume, velocity, and complexity of data generated in modern environments. The reliance on subjective assessment and periodic evaluations leads to biased and inconsistent results, undermining the reliability of the generated insights. These traditional methodologies fail to detect subtle anomalies and emerging trends due to their dependence on basic rule-based systems. Furthermore, the lack of integration with diverse data sources results in an incomplete view of an entity's interaction, such as with an external user (e.g., customer) of the system. This limitation arises from the inability of the traditional methodologies to adapt to complex, dynamic entity interactions and the lack of integration with advanced analytics and machine-learning models capable of uncovering deeper insights and predictive trends.

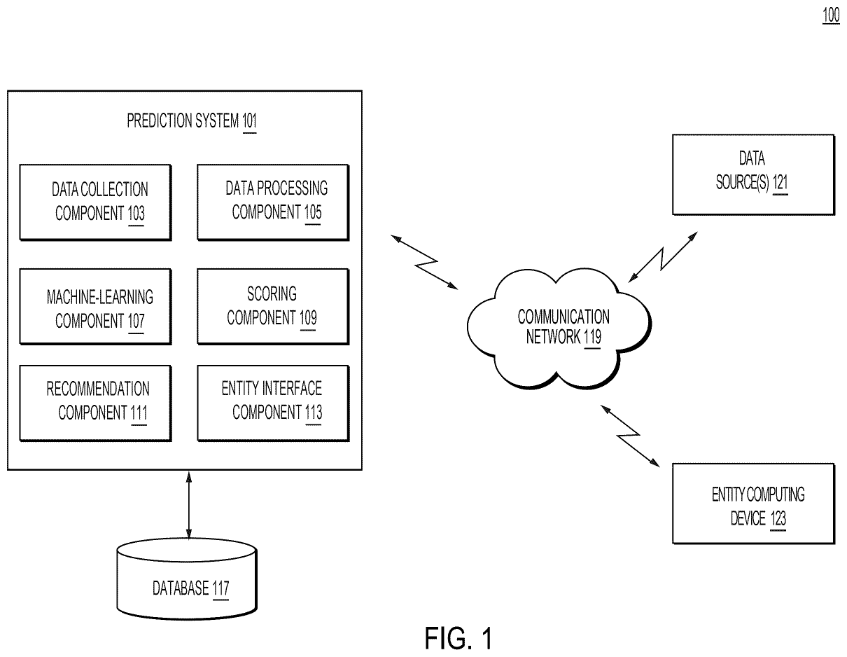

The system 100 of FIG. 1 may address the technical challenges inherent in current methodologies by utilizing a machine-learning model trained to use historical data associated with an entity to predict a risk score (also called a “predictive value” herein) indicating a likelihood (e.g., a posterior probability) that performance associated with the entity will degrade over a future time period and/or by a future time associated with the prediction. In some examples, the system 100 may comprise an additional or alternate machine-learning model trained to generate an entity-specific actionable recommendation and/or computer-executable instructions to prevent future performance degradation. In such examples, when the risk score indicates that the entity is or will become a target entity in the future, the system 100 may input, to such a trained machine-learning model, historical text data associated with the entity, causing the trained machine-learning model to generate the entity-specific instructions. As will be described herein, the input historical text data may be filtered to include only a subset of text data that meets certain constraints, thereby not only minimizing the quantity of data that is input into the trained machine-learning model to increase its processing speed, but also optimizing the input data to include relevant historical text data to increase the relevancy of the output generated by the trained machine-learning model. By leveraging advanced algorithms and filtered data ingestion, the model(s) may generate and synthesize an entity's comprehensive performance metrics, uncovering intricate patterns and predictive indicators of potential underperformance that other methods fail to detect, and efficiently generate entity-specific instructions. Accordingly, the techniques (e.g., software, hardware, machine-learned model(s), or a combination thereof) may facilitate real-time detection of target entities, enabling timely, autonomously-generated, entity-specific instructions and tailored alterations to a system used by the entity or recommendations for the entity or a supervisor of the entity.

Moreover, the machine-learning model(s) discussed herein may decrease the false negative and/or false positive rate in detecting an entity whose performance degraded over the period for which the predictions were generated. Furthermore, the model's ability to sort entities into deciles based on probability risk scores and the reduction in false negative detections may allow the system 100 to minimize the impact of other methods that might over-include entities in a subset of entities for which alterations are to be made to ameliorate a higher false negative rate. Accordingly, the techniques discussed herein may reduce entity down-time, prevent or mitigate service quality degradation, and optimize computing resource allocation by reducing needless computations by the machine-learning model(s) discussed herein (at least some of which may be energy, compute, and/or storage-intensive), network transmissions and/or data storage, and/or the like.

The machine-learning model(s) of the system 100 may employ an advanced multidimensional feature set that integrates both performance-related metrics (e.g., historical performance data) and behavioral variables (e.g., call characteristics, time spent on non-productive activities, workplace profile, entity-centric variables, etc.), representing a significant advancement over traditional approaches that typically rely on isolated performance data. In some embodiments, the historical performance data for an entity may be derived from feedback received from external user(s) who interacted with the entity. In one such embodiment, the historical performance data may be derived from the ratio of the difference between the number of promoters and detractors to the total number of surveys completed by such external users (i.e., completed user engagement scale (UES) surveys). Such ratio may be referred to as a Net Promoter Score® (NPS). Promoters may be identified as external users who express a high level of satisfaction or likelihood to recommend the entity or service provided by the entity (e.g., they provide a score of 9-10 during the post-call survey), while detractors may be identified as external users who reflect dissatisfaction or a lower likelihood to recommend (e.g., they provide a score of 1-6 during the post-call survey). The historical performance data may provide a comprehensive view of the sentiment of the external users, reflecting their overall experience. By combining these diverse variables, the system 100 may utilize sophisticated algorithms to create a multidimensional risk profile of the entity. Unlike conventional techniques that rely primarily on one-dimensional performance data, this approach may leverage a multi-dimensional data that includes certain performance data and other behavioral data to enhance predictive accuracy and offer a comprehensive assessment of potential risk factors. Consequently, the model may provide a more granular and proactive evaluation of entity performance, enabling the deployment of targeted, entity-specific instructions that address both performance deficiencies and underlying behavioral issues before they impact performance.

In the machine-learning model(s) of the system 100, features that exhibit the most significant impact on entity performance (e.g., due to their strong correlation with key outcomes such as external user satisfaction and operational efficiency) may be detected using advanced techniques, such as feature importance analysis, machine-learning algorithms, and statistical significance testing. The technical benefit of emphasizing these high-weight features may depend on their ability to drive the model's accuracy by focusing on the most influential variables. For instance, sentiment scores derived from natural language processing (NLP) techniques may provide nuanced insights into entity interaction, e.g., with an external user, while a plurality of metrics discussed herein (e.g., average handle time (AHT) metrics) may capture operational efficiency. In one example, when entity interaction involves a conversation with an external user, the NLP techniques may transcribe the speech extracted from an audio recording of the conversation into text using automatic speech recognition (ASR). The NLP techniques may tokenize the text, and may break the tokenized text into individual words or phrases. The NLP techniques may apply linguistic analysis (e.g., part-of-speech tagging, syntactic parsing, etc.) to understand sentence structure. The NLP techniques may classify the emotional tone of the text (e.g., positive, negative, neutral) by assigning polarity scores to words or phrases based on their emotional context. The NLP techniques may analyze vocal cues from the original audio (e.g., pitch, tone, or intensity) using speech signal processing to capture sentiment nuances like frustration or enthusiasm. The final sentiment scores may be derived by combining text-based and vocal-based sentiment analyses that may reflect the external user's emotions during the interaction with the entity.

By prioritizing these high-impact features, the system 100 may leverage more precise and actionable data to refine predictions and optimize decision-making. The system 100 may also detect these high-weight features and utilize the high-weight features to determine and tailor recommendations for target entities, allowing for remedial actions that are most impactful in improving the performance of the target entities. The system 100 may overcome the scalability limitation of conventional methods by providing a systematic, data-driven framework that can handle (e.g., filter) large volumes of data and entity interactions to offer predictive insights, allowing for preemptive action to mitigate risks. The integration of machine-learning algorithms with other components of the system 100 may ensure the prompt detection of subtle behavioral deviations, enhancing the model's accuracy and effectiveness. The system 100 may implement automated feedback loops that continuously refine the machine-learning model based on new data, enhancing prediction accuracy over time. The system 100 may deploy advanced data visualization tools to present actionable insights in an intuitive and accessible manner, aiding in informed decision-making.

The above technical improvements, and additional technical improvements, will be described in detail throughout the present disclosure. Also, it should be apparent to a person of ordinary skill in the art that the technical improvements of the embodiments provided by the present disclosure are not limited to those explicitly discussed herein, and that additional technical improvements exist.

FIG. 1 introduces a capability to implement modern communication and data processing capabilities into methods and systems for predicting target entities using machine-learning models. FIG. 1, an example architecture of one or more example embodiments of the present disclosure, includes the system 100 that comprises a prediction system 101, a database 117, a communication network 119, a data source 121, and an entity computing device 123.

In one embodiment, the prediction system 101 may be a platform with multiple interconnected components. The prediction system 101 may include one or more servers, intelligent networking devices, computing devices, components, and/or corresponding software for utilizing machine-learning models for predicting target entities. In addition, it is noted that the prediction system 101 may be a separate component of the system 100.

In one instance, the prediction system 101 may be configured to process complex, multidimensional data to classify entities as target individuals and generate tailored recommendations based on this classification. The prediction system 101 may receive multidimensional data, which indicates one or more values associated with different data dimensions. For example, multidimensional data may include a first set of values of a first dimension indicative of a comparison of an entity relative to a group of entities (e.g., performance-related data), and a second set of values of a second dimension indicative of an attribute of the entity irrespective of the group of entities (e.g., behavioral data). Once the data is received, it may be inputted into a first machine-learning model that may determine a risk score for the entity by applying feature importance analysis. This process may identify which features are most critical for classification and may also evaluate the relative contribution of these features to the overall risk score.

Following the classification, the prediction system 101 may utilize a second machine-learning model to generate a sequence of words, producing a detailed transcript of recommended actions tailored to the entity. In some examples, the second machine-learning model may generate the sequence of words based at least in part on a set of features associated with an entity classified by the first machine-learning model as being a target entity (e.g., high-risk entity). Additionally or alternatively, the second machine-learning model may generate the sequence of words based at least in part on a subset of features associated with an entity classified as a target entity where the subset of features are associated with score(s) determined by the first machine-learning model that satisfy a threshold score, thereby indicating that the features are salient to classifying the entity. In some examples, determining that a score satisfies a threshold score may comprise determining that the score meets or exceeds the threshold or is below a threshold, depending on how the score is configured (i.e., whether a higher score indicates greater salience or a lower score indicates greater salience). Additionally or alternatively, the second machine-learning model may use additional data associated with an entity classified as a target entity, such as historical performance trends, recent behavior patterns, call durations, feedback from external users, frequency of escalations, or time of day when performance issues are more likely to occur. The recommendations generated may be data-driven and contextually aligned with the entity's profile as determined earlier. For example, if the assessment detected a deficiency in a certain skill area, the recommendation may include targeted training sessions or mentorship opportunities.

In one embodiment, the prediction system 101 may comprise a data collection component 103, a data processing component 105, a machine-learning component 107, a scoring component 109, a recommendation component 111, an entity interface component 113, or any combination thereof. As used herein, terms such as “component” generally encompass hardware and/or software, e.g., that a processor or the like used to implement associated functionality. It is contemplated that the functions of these components may be combined in one or more components or performed by other components of equivalent functionality.

In one embodiment, the data collection component 103 may aggregate and organize data associated with one or more entities through various data collection techniques to support robust assessment and decision-making processes. In one example, the data collection component 103 may use a web-crawling component, or other component that is capable of detecting, extracting, and/or receiving data, to access various sources (e.g., the database 117, data source(s) 121, survey(s), operational log(s), or other information sources), to collect relevant data (e.g., performance metrics, behavioral patterns, contextual information) associated with the one or more entities. This process may include obtaining permission or approval from entities to collect, analyze, and utilize their performance-related data and behavioral data, adhering to privacy regulations and organizational policies. By securing entity approval, the data collection component 103 may guarantee that all data handling practices are transparent and compliant with legal and ethical standards.

In another embodiment, the data collection component may gather data from hardware sensors and/or software sensors. Hardware sensors may include microphones, keyboards, and cameras, which may capture audio, typing patterns, and visual data, respectively. Software sensors may include an activity detection system that may monitor entity engagement by analyzing log data generated from the entity's interaction with the entity computing device 123. For instance, software sensors may detect periods of inactivity, window switching, or specific application usage patterns. The hardware sensors and/or software sensors may provide a comprehensive dataset that may enhance the system's ability to assess entity behavior, engagement, and performance.

In one example, the data collection component 103 may include various software applications (e.g., data mining applications in Extended Meta Language (XML)) that may automatically search for and return historical and real-time data associated with one or more entities, thereby maintaining comprehensive and up-to-date datasets. Through seamless interaction with various databases, the data collection component 103 may capture real-time data updates, ensuring data accuracy and completeness, minimizing errors, and enhancing the reliability of the collected data.

In some examples, the data collection component 103 may receive one or more performance metrics and/or behavioral data from one or more machine-learning models, and/or one or more other data sources. These machine-learning models process data from various sources to generate key performance metrics (e.g., scores, summaries, etc.) and behavioral insights. Once generated, these outputs may be transmitted to the data collection component 103. In one example, the performance metrics may include one or more of:
(i) Change in NPS trend: The change in NPS may reflect an external user's likelihood to recommend the service over time. A positive change may indicate improved external user likelihood, while a negative change may suggest a decline in likelihood.
(ii) Change in recommendation score: The change in recommendation score may measure variations in how likely an external user is to recommend the entity or service. An increase may signify that external users are more favorable towards recommending, whereas a decrease may indicate a reduction in recommendation likelihood.
(iii) Change in resolution score: The change in resolution score may assess the effectiveness of problem resolution by the entity. A positive change may indicate improved problem-solving abilities, while a negative change may suggest challenges in resolving external user issues.
(iv) Change in satisfaction score: The change in satisfaction score may track fluctuations in overall external user satisfaction with the entity's performance. An upward trend may indicate better external user satisfaction, whereas a downward trend may suggest decreased satisfaction levels.
(v) Change in user experience score (UES) composite score: The UES composite score may be a metric for evaluating the ease of service experienced by the external user during a call. It may be calculated by weighing and combining various survey scores. The change in the UES composite score may reflect the overall impact of entity experience factors on external user perceptions. An increase may denote enhanced overall external user experience, while a decrease may indicate potential issues affecting the external user experience.

In one example, the behavioral variables may include one or more of:
(a) Change in Entity's Occupancy:
   (i) Increase in inbound calls handled.
   (ii) Increase in call length/duration (average handling time).
(b) Nature of Inventory:
   (i) Call transfer rate spike: percentage of transferred calls or change in percentage of transferred calls over a time period.
   (ii) Increase in hold times: change in average hold time.
   (iii) Change in rate of calls with negative sentiment over time or percentage of calls with negative sentiment.
(c) Time spent on non-productive activities:
   (i) Change in time devoted to special projects.
   (ii) Change in overtime hours.
   (iii) Change in meeting hours.
   (iv) Change in instruction hours.
   (v) Change in training hours.
   (vi) Change in unscheduled PTO hours.
   (vii) Change in paid leave hours.
   (viii) Change in voluntary time-off hours.
(d) Entity's Workplace Profile:
   (i) Entity's supervisor span size.
   (ii) Entity's shift timing.
   (iii) Entity's tenure.
(e) NLP-based Features:
   (i) External user's calling reason from transcripts through NLP.
   (ii) Distress Reason from Verbatim in Post Call Surveys.
(f) Entity Centric Features:
   (i) Number of times the ID card was punched by the entity.
   (ii) Number of hours/days of leave taken for sickness.
   (iii) Whether the entity filed any claim with their insurance company in the last 12 months-(Yes/No).
   (iv) Commuting passage of the entity from home to the office-(Car/Metro/Bus).
   (v) Distance between home to office.
   (vi) Skill set of the entity.
   (vii) Work experience of the entity (e.g., current and/or previous tenure, position(s) held).
   (viii) Number of times the entity changed his working organization.
   (ix) Educational Background of the entity-High School, undergraduate degree, graduate degree, post-graduate degree, PHD.
   (x) Designation/salary of the entity.
   (xi) Rewards/recognitions received in the last 12 months.
   (xii) Average of downtime/latency for tools/application/system in the last 30 days.
(g) Call Audit based features:
   (i) Percentage of calls where a dispute/rebuttal occurred in the call:
      (1) percentage of calls where process/product/system issues were detected in the call.
      (2) Percentage of calls where the entity's opportunity was observed.
      (3) Percentage of calls where positive connection was met between the external user and the entity.
      (4) Percentage of calls where compliance was met between the external user and the entity.
      (5) Average pronunciation score of the entity.
      (6) Average accent/pace of the call score of the entity.
      (7) Average grammar score of the entity.
      (8) Average effective probing choices score of the entity.
      (9) Average confidence score of the entity.
      (10) Average organization thoughtfulness score of the entity.
      (11) Average positive scripting/word choice score of the entity.
      (12) Average violation score of the entity.
      (13) Average issue resolution score of the entity.
      (14) Average background noise score of the entity.

In some embodiments, the Call Audit based features may additionally or alternatively be part of the performance metrics.

In one embodiment, the data processing component 105 may perform data standardization and/or data cleansing on the collected data. In one example, data standardization may include standardizing and unifying data so that the data are easily processed by other components. In one example, data cleansing may include removing or correcting erroneous data (e.g., redundant, incomplete, or incorrect data) to create high-quality data or validating and correcting values against a known list of entities. The data cleansing technique may also include data enhancement, where data is made more complete by adding related information. This may ensure consistency and accuracy in data interpretation, mitigating the potential impact of outliers or irregularities.

In one embodiment, the machine-learning component 107 may be configured for supervised machine-learning that utilizes training data, e.g., training data 512 illustrated in the training flow chart 500, for training a first machine-learning model to classify an entity as a target entity by processing multidimensional data and a second machine-learning model to generate a transcript containing recommended actions for the target entity. In one instance, the first machine-learning may be configured to classify an entity as a target used by processing multidimensional data. The first machine-learning may apply feature importance analysis algorithms (e.g., Gini Importance, shapley additive explanations (SHAP), or local interpretable model-agnostic explanations (LIME)) to the multidimensional data to determine which features are most significant in classifying the entity. By evaluating how different features contribute to the prediction, the first machine-learning model may determine the likelihood of an entity belonging to a specific target group. This classification process may allow the prediction system 101 to detect entities who meet specific criteria, making them targets for further diagnosis or action. In one instance, the second machine-learning model may generate a transcript containing recommended actions for the target entity. This model may take the classification result and may use it to produce a sequence of words that forms the transcript. The transcript may be designed to be specific and actionable, providing guidance tailored to the entity's unique characteristics and the assessment performed by the first machine-learning model. This two-step approach may ensure that both the classification and the recommendation processes are accurate and entity-specific, enhancing the effectiveness of the system in delivering targeted recommendations.

The machine-learning component 107 may perform model training using training data, e.g., data from other components, that contains input and ground truth data, to allow the model to learn over time. The training may comprise altering one or more parameter(s) of the model based on a difference between an output of the machine-learning component 107 determined using an input and ground truth data associated with that input. In some examples, the parameter(s) may comprise weight(s), bias(es), and/or activation function(s). For example, during the training, the weights assigned to one or more features, the bias(es), and/or the activation functions may be adjusted to minimize the difference between the predictions and the ground truth. In some examples, the ground truth data may comprise or be determined based at least in part on labeled training data, such as historical performance records, expert annotations, entity feedback, or benchmark datasets that may accurately reflect the desired output for specific inputs. In some examples, training the model may additionally or alternatively comprise determining a loss by a loss function (e.g., L1, L2, Cauchy, Huber) based at least in part on the difference between the input and the ground truth data and altering the one or more parameter(s) of the model to reduce the loss subject to a gradient descent or other loss optimization algorithm. By leveraging the labeled dataset, the machine-learning model may iteratively adjust its parameters and optimize its predictive capabilities to develop an accurate algorithm for detecting target entity(s) and/or generating a transcript containing recommended actions.

Additionally or alternatively, training the machine-learning component 107 may comprise randomizing the ordering of the training data, visualizing the training data to detect relevant relationships between different variables, determining any data imbalances, and splitting the training data into two parts where one part is for training a model and the other part is for validating the trained model, de-duplicating, normalizing, correcting errors in the training data, and so on. The first machine-learning model discussed herein may comprise a machine-learning architecture for classifying an entity based at least in part on feature data, such as deep-learning model(s); neural network(s) (e.g., recurrent neural network, graph convolutional neural network, deep neural networks); support vector machine(s); Bayesian models; a set of decision trees (e.g., a bootstrap aggregated (“bagged”), boosted, or stacked ensemble model, which may comprise Gradient boosted machines (GBM), LightGBM (LGBM), extremely randomized trees (extra trees) classifier); and/or the like. The second machine-learning model discussed herein may comprise a machine-learning architecture for generating text and/or image(s) from input text, feature(s), embedding(s), and/or the like, such as a transformer-based machine-learned model(s), autoencoder(s), generative adversarial network(s), diffusion model(s), hidden Markov model(s), and/or the like.

In one instance, the scoring component 109 may comprise the first machine-learning model and may quantify a future risk associated with an entity based at least in part on performance-related variables and/or behavioral variables associated with the entity. For example, the scoring component 109 may leverage the first machine-learning model to generate a risk score that may quantify the probability of future poor performances. The scoring component 109 may utilize the first machine-learning model to assign weights to the performance-related variables and the behavioral variable, with different factors contributing to the final score based on their relative importance. By employing techniques, such as feature importance analysis, the first machine-leaning model may assess how changes in each variable may impact overall performance, allowing the scoring component 109 to assign appropriate weights that may reflect each variable's relative importance in the scoring process. For example, high-impact performance indicators like resolution rates or external user satisfaction might have greater weight compared to less significant behavioral traits. These weighted factors may be combined to calculate a composite score. These scores may serve as a tool for classifying entities, such as detecting target or non-target entities, and may trigger specific actions (e.g., entity-specific instructions generated by a machine-learning model). Additionally, the scoring component 109 may offer insights by highlighting the factors that most significantly influence the score, enabling targeted recommendations for improvement.

In one instance, the recommendation component 111 may comprise the second machine-learning model and may process the scores determined by the scoring component 109, along with contextual data such as historical trends, peer comparisons, and/or outliers detected from the entity's interactions with a computing device to generate tailored recommendations for entities. The recommendation component 111 may detect key areas where the entity may need improvement or support, and generates specific actions or strategies that the entity can implement to enhance their performance. These recommendations may be actionable and relevant, focusing on areas such as skill development, behavior modification, or workflow adjustments. In one example, the recommendation component 111 may utilize prompt templates to generate tailored recommendations by integrating data collected from entity interactions and performance metrics. For example, the prompt templates may outline the specific elements needed to formulate a recommendation. These prompts are then processed by the second machine-learning model (which may comprise one or more models, each of these models configured to generate its respective part of the recommendation), such as identifying skill gaps, suggesting behavior modification, or recommending workflow adjustments.

If an entity's performance score indicates a recurring issue with time management, the recommendation component 111 may recommend targeted time management training or suggest tools to improve efficiency. The recommendation component 111 may generate recommendation(s) for an entity as discrete portions of text that may be stored as part of a structure data object or may generate the structure data object itself, where the data object includes the recommendation(s). A non-limiting example of a tabular view of the data object is given below.

| | | Average | | |
|---|---|---|---|---|
| | Average | Conference Time | Unscheduled | |
| | Resolution | Spent During | PTO's taken | |
| | Score of Calls | Calls in Last 7 | by Entity in | |
| Entity ID | in Last 60 Days | Days | Last 90 Days | Recommendations |
| 00RT67Y5 | Medium Risk | Medium Risk | High Risk | 1. Ensure proper greeting and |
| | | | | introduction to the provider at |
| | | | | the beginning of the call. |
| | | | | 2. Take ownership of the call |
| | | | | and provide clear explanations |
| | | | | and solutions to the provider's |
| | | | | concerns. |
| | | | | 3. Improve active listening skills |
| | | | | and avoid unprofessional |
| | | | | behavior such as laughing |
| | | | | during the call. |
| | | | | 4. Consult supervisor or |
| | | | | escalate issues when unable to |
| | | | | provide a solution. |
| | | | | 5. Improve communication skills |
| | | | | and avoid using unclear or |
| | | | | incomplete phrases. |
| 001I89OV | High Risk | Low Risk | Low Risk | 1. Verify patient information |
| | | | | accurately to avoid mismatches. |
| | | | | 2. Ensure access to necessary |
| | | | | information and minimize the |
| | | | | need for transferring calls. |
| | | | | 3. Provide accurate and timely |
| | | | | updates on claim status and |
| | | | | next steps. |
| | | | | 4. Improve knowledge about |
| | | | | policy details and department |
| | | | | information. |
| | | | | 5. Pay attention to detail and |
| | | | | avoid making mistakes when |
| | | | | recording information. |
| 00VC10PG | Medium Risk | Low Risk | Low Risk | 1. Provide accurate mailing |
| | | | | addresses and timely filing limits |
| | | | | 2. Offer willingness to take a |
| | | | | brief survey with additional |
| | | | | information. |
| | | | | 3. Avoid expressing frustration |
| | | | | or impatience. |
| | | | | 4. Provide correct and accurate |
| | | | | information about copays, |
| | | | | deductibles, and coverage |
| | | | | 5. Verify information before |
| | | | | making assumptions. |
| 00C5TY7U | Medium Risk | Very High Risk | Medium Risk | 1. Provide technical support to |
| | | | | address the recurring issue of |
| | | | | not being able to hear the |
| | | | | provider well during calls. |
| | | | | 2. Train agents on how to |
| | | | | properly verify claim numbers |
| | | | | and effectively communicate |
| | | | | claim status. |
| | | | | 3. Educate agents on policy |
| | | | | coverage and effective denial |
| | | | | explanations. |
| | | | | 4. Improve agent's knowledge of |
| | | | | out-of-network lab denials and |
| | | | | provide assistance in resolving |
| | | | | such issues. |
| | | | | 5. Train agents on the |
| | | | | importance of gathering all |
| | | | | necessary information upfront to |
| | | | | avoid confusion later. |
| 00LO6FC2 | Low Risk | High Risk | Very High | 1. Ensure a clear connection |
| | | | Risk | and minimize static noise on the |
| | | | | line. |
| | | | | 2. Improve the ability to pull up |
| | | | | claims and provide resolutions |
| | | | | to issues. |
| | | | | 3. Always ask for the patient's |
| | | | | last name initial and have |
| | | | | access to the relevant account |
| | | | | information. |
| | | | | 4. Ensure correct tax IDs are |
| | | | | entered and have accurate |
| | | | | contact information for relevant |
| | | | | departments. |
| | | | | 5. Provide a clear resolution for |
| | | | | the provider's issue instead of |
| | | | | suggesting submitting a ticket on |
| | | | | the website. |

In one instance, the entity interface component 113 may generate one or more transcripts based on the data from the recommendation component 111. For example, the transcript(s) may summarize the entity's performance assessment, which may include suggested training programs to improve specific skills, identified behavioral patterns that may affect productivity, or recommended adjustments to workflows that may enhance efficiency. The transcript may be then displayed in the entity interface of the entity computing device 123. The transcripts may include one or more of: recommended action(s), which may outline specific steps for improving performance or addressing detected issues; indication(s) of resources, such as links to training documents, guidelines, or tools that support the implementation of recommended actions; timeline(s) detailing the schedule for implementing the recommended actions; and/or progress monitoring measures, which track the effectiveness of the recommendations and adherence to the proposed actions. The entity interface component 113 may employ various application programming interfaces (APIs) or other function calls corresponding to the application of the entity computing device 123, thus enabling the display of graphics primitives such as icons, bar graphs, menus, buttons, data entry fields, etc. The entity interface component 113 may also cause interfacing of guidance information to include, at least in part, one or more annotations, audio messages, video messages, or a combination thereof pertaining to the transcript or recommended actions.

The above presented components of the prediction system 101 may be implemented in hardware, software, or a combination thereof. Though depicted as a separate entity in FIG. 1, it is contemplated that the prediction system 101 may also be implemented for direct operation by the respective entity computing device 123. In another embodiment, one or more of the components 103-115 may be implemented for operation by the respective UEs, as the prediction system 101. The various executions presented herein contemplate any and all arrangements and models.

In one embodiment, the database 117 may be any type of database, such as relational, hierarchical, object-oriented, and/or the like, wherein data are organized in any suitable manner, including data tables or lookup tables. The database 117 may access or include any suitable data that may be utilized to predict the condition of one or more entities. In one embodiment, the database 117 may include a machine-learning based training database with a pre-defined mapping defining a relationship between various input parameters and output parameters based on various statistical methods. For example, the machine-learning models discussed herein may learn mappings between input parameters related to the entities (e.g., performance metrics, behavioral variables) and classification(s), score(s), and/or, recommendations or previous outputs of the machine-learning models may be associated with the respective inputs that resulted in those outputs as a mapping. In one example, the database 117 may store content associated with one or more entities and the prediction system 101, and may manage multiple types of information that provide means for aiding in the content provisioning and sharing process. Advanced security measures may be implemented to safeguard sensitive information, including encryption, access controls, and regular backups. The database 117 may be integrated with the data processing component 105 to facilitate real-time data retrieval and updates, enabling dynamic and informed decision-making.

In one embodiment, various elements of the system 100 may communicate with each other through the communication network 119. The communication network 119 may support a variety of different communication protocols and communication techniques. In one embodiment, the communication network 119 may allow the prediction system 101 to communicate with the entity computing device 123. The communication network 119 of the system 100 may comprise a wired and/or wireless network. It is contemplated that the network may be configured as any local area network (LAN), metropolitan area network (MAN), wide area network (WAN), a public data network (e.g., the Internet), short range wireless network, and/or any other suitable packet-switched network, such as a commercially owned, proprietary packet-switched network, e.g., a proprietary cable or fiber-optic network, and the like, or any combination thereof. A wireless network may comprise, for example, a cellular communication network (e.g., 5G (5th Generation), 4G, 3G, 2G, Long Term Evolution (LTE)), wireless fidelity (Wi-Fi), short-range wireless (e.g., Bluetooth®), Internet Protocol (IP) data casting, satellite, mobile ad-hoc network (MANET), vehicle controller area network (CAN bus), and/or the like, or any combination thereof.

By way of example, the prediction system 101, the database 117, the data source(s) 121, and the entity computing device 123 may communicate with each other and other components of the communication network 119 using well known, new or still developing protocols. In this context, a protocol may include a set of rules defining how the network nodes within the communication network 119 interact with each other based on information sent over the communication links. The protocols are effective at different layers of operation within each node, from generating and receiving physical signals of various types, to selecting a link for transferring those signals, to the format of information indicated by those signals, to detecting which software application executing on a computer system sends or receives the information.

In one instance, data source 121 may encompass a variety of origins from which data is collected and integrated into the system. These sources may be categorized into structured databases, such as relational databases and data warehouses, which may provide organized and easily queryable data; semi-structured sources including XML and JSON files that contain data with a defined schema but flexible structure; and unstructured sources, such as text documents, emails, and social media feeds, which may require advanced processing techniques to extract meaningful information. Additionally, data sources may include real-time streams from sensors, logs, or APIs that offer continuous updates and insights. The integration of these diverse data sources may enable a comprehensive assessment by consolidating information across different formats and contexts, ensuring that the system can leverage a wide array of data for more accurate and actionable insight.

In one instance, the entity computing device 123 may include, but is not restricted to, any type of mobile terminal, wireless terminal, fixed terminal, or portable terminal. Examples of the entity computing device 123, may include, but are not restricted to, a mobile handset, a wireless communication device, an Internet node, a desktop computer, a laptop computer, a Personal Communication System (PCS) device, a personal navigation device, any other personal or enterprise computing device, or any combination thereof, including the accessories and peripherals of these devices, or any combination thereof. In one example, the entity computing device 123 may display the transcript generated by the prediction system 101. The transcript may be converted into an audio format and played through speakers, allowing the entities to listen to the recommendations. Alternatively, the computing device 123 may generate visual content, such as graphical representation or annotated images, to present the transcript on a display, enhancing entity engagement. Additionally, the transcript may be translated into instructions for haptic feedback, enabling the computing device 123 to provide physical nudges or vibrations that guide the entity's actions. The transcript often features recommendations for improving performance or addressing detected issues, timelines, and progress monitoring measures in an intuitive format, such as charts or graphs. In one embodiment, applications at the entity computing device 123 may act as a client for the prediction system 101 and may perform one or more functions associated with the functions of the prediction system 101 by interacting with the prediction system 101 over the communication network 119. Any known and future implementations of the entity computing device 123 may also be applicable.

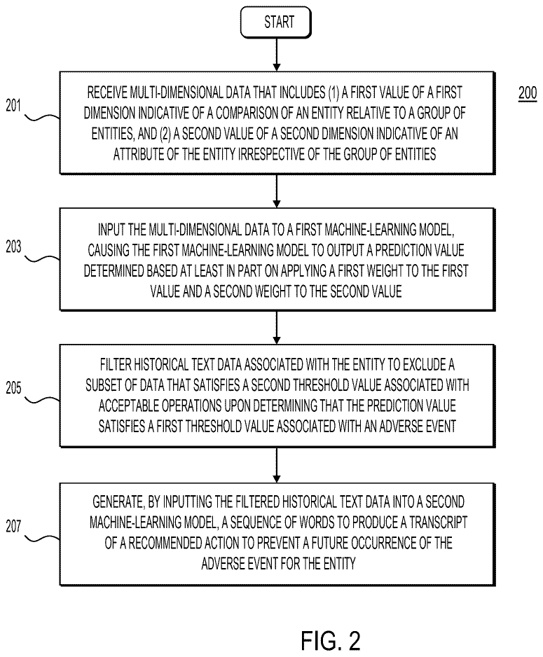

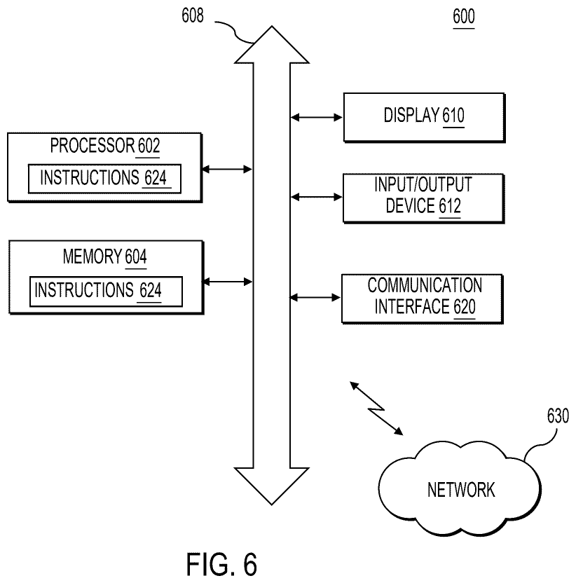

FIG. 2 illustrates a flowchart of an example process for generating a risk score indicating a predicted likelihood that an entity is or will become a target entity in the future and generating entity-specific recommendations based on multidimensional data and using machine-learning models, according to aspects of the disclosure. In various embodiments, the prediction system 101 and/or any of the components 103-113 may perform one or more portions of the process 200 and are implemented using, for instance, a chip set including a processor and a memory as shown in FIG. 6. As such, the prediction system 101 and/or any of components 103-113 may provide means for accomplishing various parts of the process 200, as well as means for accomplishing embodiments of other processes described herein in conjunction with other components of the system 100. Although the process 200 is illustrated and described as a sequence of steps, it is contemplated that various embodiments of the process 200 may be performed in any order or combination and need not include all of the illustrated steps.

In step 201, the prediction system 101 may receive multi-dimensional data that may include a first value of a first dimension indicative of a comparison of an entity relative to a group of entities, and a second value of a second dimension indicative of an attribute of the entity irrespective of the group of entities. In one instance, the first dimension may include a performance-related variable that may indicate a quantitative measure of the past performance of the entity. The performance-related variable may be received responsive to transmitting a query to an external user's computing device upon detecting the completion of an interaction between a computing device associated with the entity and the external user's computing device. In one example, after a service call between the entity and the external user, the prediction system 101 may detect the end of the interaction and may send a query requesting feedback to the external user's computing device. The performance-related variable of the entity may include a change in one or more of an NPS, a recommendation score, a resolution score, a satisfaction score, and/or a user experience score (UES).

In one instance, the second dimension may include a behavioral variable that may indicate a quantitative or qualitative measure of interaction style, engagement level, and/or workplace profile associated with the entity. The behavioral variable of the entity may include occupancy data, inventory data, temporal data associated with non-productive activities, workplace profile data, natural language processing (NLP) based features, entity-centric features, and/or call-audit based features. By integrating the first and second dimensions, this approach may allow for a more comprehensive assessment of the entity's performance or behaviors within a broader context, enhancing the precision and relevance of recommendations.

In step 203, the prediction system 101 may input the multi-dimensional data to a first machine-learning model. The first machine-learning model may be a set of decision trees trained to output a prediction value determined based at least in part on applying a first weight to the first value and a second weight to the second value. In one example, a feature importance analysis algorithm may be utilized to evaluate and rank the relative significance of each input feature to determine how strongly each one contributes to the overall prediction (e.g., the likelihood of the entity being classified as a target entity). By applying this analysis, the first machine-learning model may detect which features have the most substantial impact on the prediction value. For example, if certain features are determined to be more predictive of an entity's future success or risk, these features may be weighted more heavily in the decision-making process. This approach may ensure that prediction is influenced more heavily by the inputs that have proven to be more indicative of the target outcome, thus enhancing the reliability and performance of the first machine-learning model.

In one instance, training the first machine-learning model may include using a training dataset associated with a set of sample entities. The training dataset may include a set of performance-related training variables and behavioral training variables. The prediction system 101 may associate a first classification with a first sample entity of the set of sample entities based on a subset of the training dataset associated with the first sample entity. The prediction system 101 may determine an estimated value based on a subset of the set of performance-related training variables and the behavioral training variables associated with the first sample entity. The prediction system 101 may determine that the estimated value satisfies the first threshold value, indicating that the first sample entity is associated with a second classification. The prediction system 101 may determine, based at least in part on a first difference between the second classification and the first classification or a second difference between the estimated value and a value associated with the first classification, a loss. The prediction system 101 may modify one or more parameters of the first machine-learning model to reduce the loss.

In one instance, the classification may include two distinct forms: as a score or value, or as an actual category assigned to the entity. When represented as a score or value, the output may provide a numerical indication of the likelihood that an entity belongs to a specific group, such as a target entity. For example, this value may comprise a logit indicating a likelihood (e.g., a posterior probability) determined by the model. A high score may indicate a greater probability that the entity may be at target or in need of entity-specific instructions, while a lower score suggests the opposite. This numerical approach may allow for a granular assessment, enabling the system to rank entities according to their risk levels or other relevant metrics.

In one instance, the first machine-learning model may use a gradient boosting technique to enhance the classification of the entity as a target entity, ensuring high accuracy and robustness in decision-making. Gradient boosting may be an advanced ensemble learning method that builds machine-learning model(s) in a sequential manner, where each new model may be trained to correct the errors of the previous models. This method may combine weak learners, typically decision trees, into a single machine-learning model by iteratively fitting new models to the residuals (errors) of the combined predictions from prior models. In this context, the first machine-learning model may iteratively improve its performance by employing the training algorithm that focuses on misclassified instances from earlier iterations. This training process may utilize loss optimization techniques and decision functions to refine the model's prediction, effectively minimizing errors and enhancing overall accuracy with each iteration.

In one instance, the prediction system 101 may evaluate the performance of the first machine-learning model utilizing a gain/lift measure. The gain/lift measure may quantify the accuracy of the first machine-learning model by sorting a plurality of entities, which the first machine-learning model has classified, into one or more deciles based on the respective classifications. The gain/lift measure may determine a lift for a first decile by determining a difference between (i) a first ratio of the entity in the first decile and classified by the first machine-learning model as a target entity by determining the predictive value satisfied the first threshold to the total number of entities in the first decile, and (ii) a total number of target entities classified by a rule-based method to a total number of entities. In one instance, a top decile of one or more deciles may include entities with the highest-risk probabilities, a middle decile of one or more deciles may include entities with moderate-risk probabilities, and a lower decile of one or more deciles may include entities with lowest-risk probabilities.

The prediction system 101 may determine that the prediction value satisfies a first threshold value associated with an adverse event. In one instance, the first threshold value may represent a rank (e.g., positioning the entity within a certain top percentile compared to a set of entities) or a probability indicating the level of confidence regarding whether the entity warrants further investigation due to the potential for the adverse event. In one instance, the adverse event may encompass various negative occurrences, including adverse calls to external users. In one example, satisfying the threshold value may include determining the predictive value meets or exceeds the first threshold value, where an increase in the predictive value may indicate an elevated risk of the adverse event occurring. In another instance, satisfying the threshold value may include determining the predictive value is below the first threshold value, wherein decreasing predictive values may suggest a diminishing likelihood of the adverse event.

In step 205, the prediction system 101 may filter historical text data associated with the entity to exclude a subset of data that may satisfy a second threshold value associated with acceptable operations. In one instance, the prediction system 101 may implement a targeted filtering process to enhance its analysis of entity interactions by focusing on data that highlights negative performance indicators. After identifying entities of interest, the prediction system 101 may exclude historical data that reflects acceptable operations, such as positive calls to external users. This selective approach may ensure that only adverse call data (e.g., interactions that may signify problems or failures) are retained for further evaluation. By concentrating on this subset of negative interactions, the prediction system 101 may provide the second machine-learning model with a dataset that captures the nuances of problematic behavior.

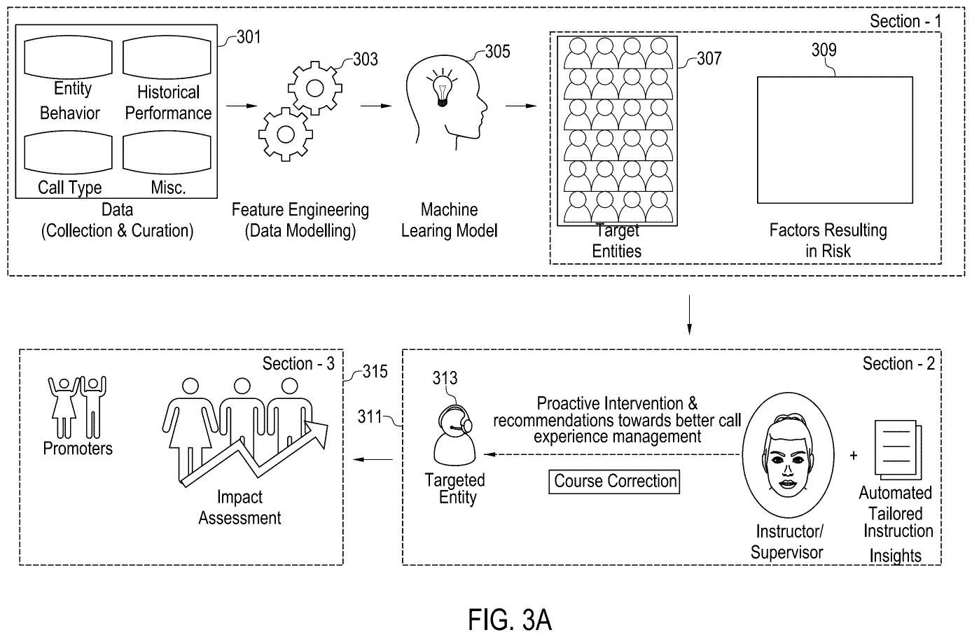

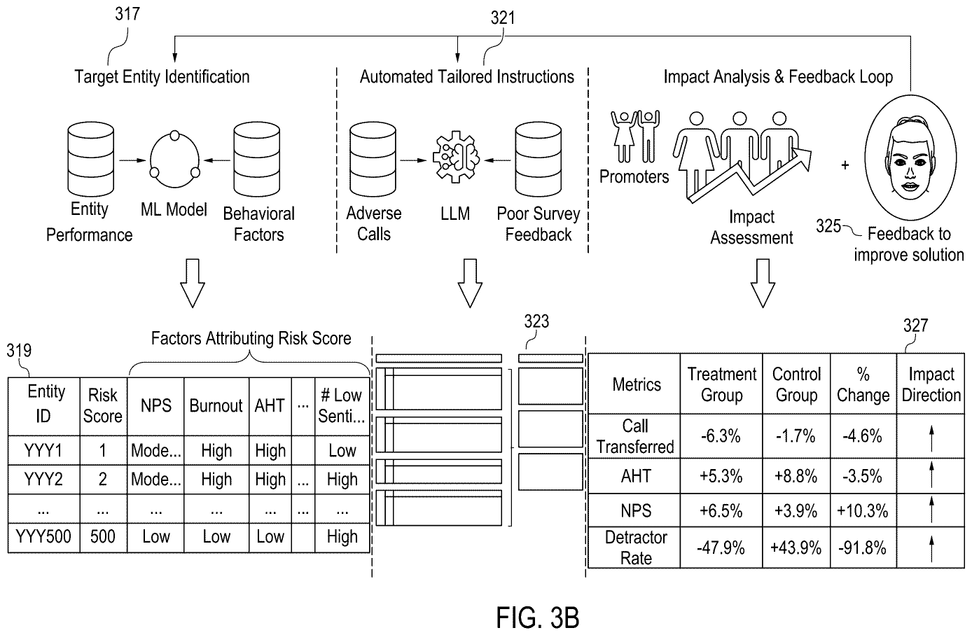

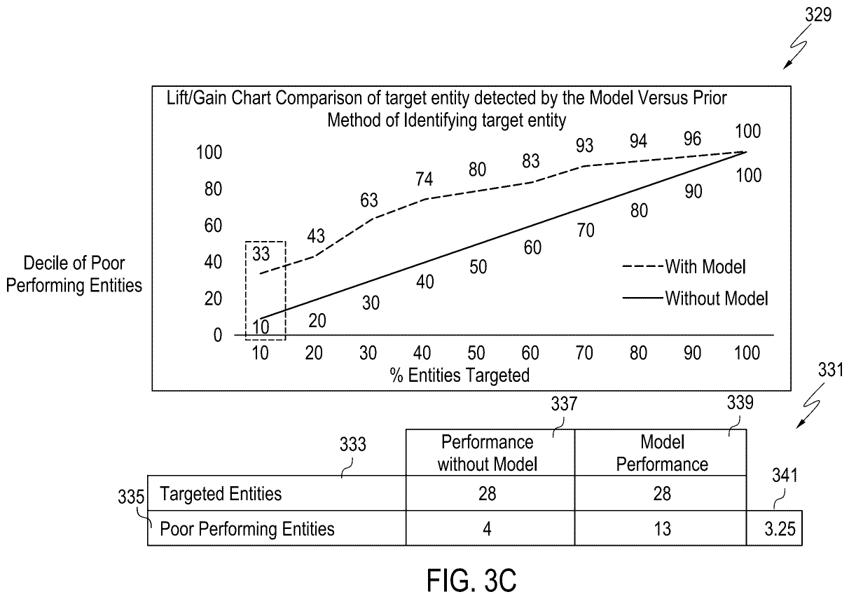

In step 207, the prediction system 101 may input the filtered historical text data into a second machine-learning model for generating a sequence of words to produce a transcript of a recommended action to prevent a future occurrence of the adverse event for the entity. The second machine-learning model may include a large language model, generative adversarial network, a variational autoencoder, a recurrent neural network, a transformer-based model, or a reinforcement learning model. In one instance, the second machine-learning model may determine one or more features that contributed most to the classification of the target entity by analyzing the filtered historical text data through advanced algorithms. In one example, for an entity classified as target, the second machine-learning model may determine that certain features, such as low-performance scores, frequent negative feedback, or high absenteeism, may be the primary contributors. The key contributing factors may also include issues or indicators of poor performance detected through the process explained below in reference to steps 321 and 323 in FIG. 3B. Once these key contributing features are detected, they become the foundation for generating a transcript that may include recommended actions tailored to address the specific issues highlighted by the assessment. The transcript may incorporate detailed recommendations that directly correlate with the detected features. For example, if poor performance scores were a significant factor, the transcript may include actions such as additional training, mentoring, or specific performance improvement plans. The targeted nature of the recommendation may ensure that the suggested actions are relevant and effective in addressing the root causes of the entity's classification as a target entity. This may enhance the precision and effectiveness of the entity-specific instructions, providing a clear and actionable path for improvement.

In one instance, the prediction system 101 may track, in real-time or near real-time, adherence to the recommended action by the entity to evaluate the effectiveness of those recommendations. The prediction system 101 may monitor one or more actions performed by the entity to verify the completion of the recommended action. After the entity has completed the recommended action, the prediction system 101 may compare the entity's updated performance metrics against a pre-determined performance threshold. This comparison may assess whether the entity's performance has improved as expected or if further entity-specific instructions may be needed. By tracking adherence and performing this comparison, the prediction system 101 may validate the impact of its recommendations and may refine future suggestions.

FIG. 3A illustrates an example for predicting target entities and providing entity-specific instructions generated by a machine-learning model to improve performance, according to aspects of the disclosure.

In step 301, the prediction system 101 may collect relevant data from multiple sources. The sources may include at least one of:
(i) Entity behavior data: Information about the behavior of call center entities, such as response time, adherence to scripts, call handling techniques, or interaction quality.
(ii) Historical performance data: Entity's past performance metrics, including call resolution rates, external user's satisfaction scores, and sales figures.
(iii) Call type data: Classification of calls based on type (e.g., support, sales, complaints) which may help in understanding different performance drivers and challenges across call types.
(iv) Miscellaneous data: Any additional data that may affect performance, such as workload, shift, timings, and external factors influencing entity performance.

The prediction system 101 may curate the data. This may involve cleaning, organizing, and structuring the collected data to ensure accuracy and consistency. The tasks may include handling missing values, removing duplicates, normalizing data formats, and transforming raw data into a structured format suitable for assessment.

In step 303, the prediction system 101 may perform feature engineering (data modeling). This may include:
(i) Feature selection: detecting and selecting relevant features (attributes) from the curated data that may have a significant impact on entity performance. In one example, prediction system 101 may gather metrics like average call handling time, external user feedback scores, or number of escalated calls. Statistical methods and machine-learning algorithms may analyze the correlations between these metrics and performance, and may assign importance (e.g., scores) to the most influential features. This process may ensure that the prediction system 101 focuses on key factors, improving prediction accuracy.
(ii) Feature extraction: creating new features from existing data that may help improve the model's performance. For example, the prediction system 101 may extract relevant time-based information from raw data (e.g., temporal features like time of the day or day of the week from call data). The extracted raw data may be transformed using various algorithms into useful features, like calculating time intervals, grouping data into periods (e.g., morning vs. afternoon), or detecting patterns (e.g., detecting patterns related to peak performance time occurring in the afternoon or during weekdays). This may facilitate the prediction system 101 to understand when an entity is most effective.
(iii) Data transformation: Applying techniques such as scaling, encoding categorical variables, and/or aggregating data to prepare it for modeling. This may ensure that the features are in a format that can be efficiently used by machine-learning algorithms.

In step 305, the prediction system 101 may train a machine-learning model. In one instance, the machine-learning model may be trained using historical data, and thereafter, it may operate in an inference phase, applying the trained model to make predictions based on new incoming data. The machine-learning model may be retrained periodically or when performance metrics indicate a decline in accuracy, ensuring the machine-learning model remains effective in adapting to any emerging patterns or changes in data. In this instance, the steps include:
(i) Model Selection: Choosing appropriate machine-learning algorithms based on the problem type and data characteristics. In one example, the first machine-learning model may be selected to analyze multi-dimensional data to classify an entity as a target entity. In another example, the second machine-learning model may be selected to generate a detailed transcript of recommended actions for the target entity. By selecting algorithms that align with the dataset and desired outcomes, the system may improve predictive performance and operational efficiency.
(ii) Model Training: Using the prepared data to train the selected machine-learning model. This process may begin with data preprocessing, where the input data may be cleaned and transformed to ensure consistency and accuracy. The processed data may be fed into the algorithm, which may systematically analyze the features and their interactions to learn patterns and relationships indicative of target behaviors. During this phase, the algorithm may undergo iterative adjustments and may optimize its parameters to accurately predict target behaviors.
(iii) Model Evaluation: Assessing the model's performance using metrics such as accuracy, precision, or recall. This step may ensure that the model is capable of accurately predicting target entities and can be refined if necessary.
(iv) Model Tuning: Adjusting model parameters and hyperparameters to improve performance. This may involve techniques such as cross-validation, grid search, or random search to find the best configuration of the model.

In step 307, the prediction system 101 may classify a subset of entities as target entities. In one embodiment, the prediction system 101 may utilize the trained machine-learning model to detect entities who are at target of poor performance or external user dissatisfaction. This may involve using the machine-learning model to evaluate new data (e.g., recent entity performance metrics and behavioral indicators) and generating risk scores for each entity. For example, a numerical risk score may assigned to each entity based on the model's predictions. Higher scores may indicate a higher likelihood of underperformance or external user dissatisfaction.

In step 309, the prediction system 101 may detect the factors contributing to target scores. This may include assessing specific behaviors, performance metrics, and/or external conditions that are correlated with target. The prediction system 101 may determine the underlying causes of risk by examining patterns and anomalies in the data. This may involve analyzing entity-specific performance issues, group dynamics, and/or other contributing factors. In one example, the prediction system 101 may detect frequent instances of delayed responses or escalated complaints associated with calls with the entity, which are performance metrics linked to higher risks. The prediction system 101 may process patterns and anomalies across data inputs, such as consistent issues in response time or repeated challenges with specific tasks. Such processing may reveal that the entity's delay may stem from either entity-specific performance issues, such as lack of familiarity with certain procedures, or group-level dynamics, such as inadequate support during peak times.

In step 311, the prediction system 101 may provide tailored recommendations to instructors and supervisors based on the detected risk factors. In one example, the prediction system 101 may analyze specific risk factors detected for each entity, and may evaluate these risk factors against a predefined set of rules. The prediction platform may generate tailored recommendations that may include suggested areas for improvement, specific skills to focus on, and strategies for effective instructions. The prediction system 101 may leverage automation to generate instruction insights and recommendations. This may involve using algorithms to analyze performance data and generate actionable feedback that may be automatically delivered to instructors or supervisors. In one instance, one or more machine-learning models may generate a recommendation based on one or more features that have been determined to contribute most to the classification of the target entity. The one or more machine-learning model may include a large language model, generative adversarial network, a variational autoencoder, a recurrent neural network, a transformer-based model, a reinforcement learning model, and/or a combination thereof. In one example, for an entity classified as target, the machine-learning model(s) may determine that certain features, such as low-performance scores, frequent negative feedback, or high absenteeism, may be the primary contributors. Once these key contributing features are detected, they become the foundation for generating a transcript that may include recommended actions tailored to address the specific issues highlighted by the assessment. The transcript may incorporate detailed recommendations that directly correlate with the detected features. For example, if poor performance scores were a significant factor, the transcript may include actions such as additional training, mentoring, or specific performance improvement plans. In another example, the prediction system 101 may determine that the delayed responses were due to unfamiliarity with specific procedures, whereupon the prediction system 101 may recommend targeted skill development sessions or guided tutorials. Additionally, if group dynamics like inadequate support during peak times are contributing to the risk, the recommendations may include workflow adjustments, such as reassigning tasks or increasing team support during high-volume periods.

The prediction system 101 may implement strategies and actions to address detected risks before they impact performance. In one example, the prediction system 101 may implement automated decision-making processes to implement strategies and actions that address detected risk proactively. Upon identifying a potential risk, the prediction system 101 may automatically trigger entity-specific instructions. This may include scheduling additional training, modifying call handling procedures, or adjusting workloads. The prediction system 101 may offer specific recommendations to improve call experience management. This may involve changes in call scrips, enhancements in external user interaction techniques, or adjustments in performance metrics.

In step 313, the prediction system 101 may transmit algorithmically-developed recommendations, which were discussed above in reference to step 311, to target entities. These plans may be designed to address specific issues and enhance performance. The prediction system 101 may continuously monitor the performance of entities who receive instructions to assess the effectiveness of the instructions and adjust the subsequent instructions as needed.

In step 315, the prediction system 101 determines metric(s) indicating the impact of the entity-specific instruction on entity performance. Determining these metric(s) may comprise determining whether key performance metrics, such as call resolution rates, external user's satisfaction scores, overall productivity, etc. increased or decreased over time. The prediction system 101 may utilize the result of the impact assessment to refine and improve the machine-learning model, feature engineering process, and/or generation of entity-specific instructions. For example, the impact assessment may reveal that certain features, such as call duration or external user satisfaction scores, may be strongly correlated with entity performance, and the prediction system 101 may prioritize these features during the feature engineering process, potentially creating new variables or modifying existing ones to better capture the relevant patterns. Additionally, insights from the assessment may highlight gaps in the entity-specific instructions, prompting adjustments in the approach taken for target entities. This may ensure that the system remains optimized and adapts to changes in performance needs. The prediction system 101 may generate detailed reports on the outcomes after delivery of the entity-specific instructions to the entity, and the overall effectiveness of the machine-learning model. This may facilitate stakeholders to understand the value of the system and make informed decisions.

FIG. 3B illustrates an example process of detecting target entities and determining the impact of instructions generated by a machine-learning model, according to aspects of the disclosure.

In step 317, the prediction system 101 may collect data on entity performance and behavioral factors. In one example, entity performance may refer to various performance metrics related to individual entities, such as call handling times, resolution rates, and adherence protocols. Key performance indicators (KPIs) may include average handle time (AHT), number of outstanding service requests (NOS), and external user's satisfaction ratings. In one example, behavioral factors may include attributes and behaviors observed in entities that may contribute to their risk profile. Factors such as burnout levels, sentiment analysis of call content, and patterns in external user interactions may be considered. For example, low sentiment in calls may indicate negative external user experiences, while high burnout levels may suggest reduced performance due to fatigue.

The prediction system 101 may input the collected data into the machine-learning model to analyze and generate risk scores for a specific entity.

In step 319, the machine-learning model may evaluate various inputs, such as entity ID, NPS, burnout, average handle time (AHT), and/or sentiment analysis. The machine-learning model may output a risk score for each entity, detecting those who are at target of underperformance or negative impact on external user's experience.

In step 321, the prediction system 101 may generate automated tailored instructions. This may include collecting data from adverse calls and poor survey feedback. In one example, adverse calls may include calls where the external user experience was poor, often indicated by negative feedback or escalation. The data may include call recording, reasons for external user dissatisfaction, and overall interaction quality. In one example, poor survey feedback may refer to negative responses or low scores from post-call surveys completed by external users. Survey feedback may include ratings on various aspects of the service, such as clarity, empathy, and resolution effectiveness. The prediction system 101 may input the collected data into the machine-learning model (e.g., large language model (LLM)) for advanced analytical processing to detect suboptimal performance metrics associated with each entity (e.g., worst-performing calls) and relevant indicators of underperformance. The prediction system 101 may generate actionable recommendations based on the results of the assessment. The machine-learning model may assess the intents and the issues expressed by the external users during interactions, such as quantifying a provider's frustration concerning card activation workflows.

In step 323, the machine-learning model may extract detailed analytics regarding the specific challenges encountered during an interaction (e.g., calls), such as the intent of the call (e.g., card activation) and the issues (e.g., external user frustration). For instance, if an entity's call intent was to activate a card and they repeatedly expressed dissatisfaction, the prediction system 101 may highlight these calls for tailored instructions. For example, the prediction system 101 may recommend entity-specific strategies for improving external user satisfaction during card activation calls, such as offering additional training on troubleshooting techniques, adjusting workflows for smoother card activation processes, or suggesting follow-up actions to ensure the external user's needs are fully met. By tailoring these recommendations to the unique issues identified in each call, the system may improve overall service effectiveness and reduce repeat issues in future interactions.

In step 325, the prediction system 101 may perform impact analysis and may implement a feedback loop. In one instance, the impact assessment may involve evaluating the effectiveness of the entity-specific instructions by measuring resulting changes in performance metrics. This may include comparing the performance of entities who received instructions with those who did not. In one instance, the feedback loop may incorporate findings from the impact assessment to continuously refine and improve the machine-learning model and instruction strategies. This loop may ensure that the system evolves based on real-world outcomes and feedback.

In step 327, the prediction system 101 may generate a table to compare various metrics before and after delivery of entity-specific instructions to the entity. The table may include:
Metrics: Specific performance indicators like average handle time (AHT), external user satisfaction scores, and call resolution rates.
Target Group: Entities that received the entity-specific instructions.
Control Group: Entities that did not receive instructions.
% change: The percentage change in performance metric for both target and control groups.
Impact direction: Direction of the impact (positive or negative) observed due to the entity-specific instructions.

This may allow for understanding the effectiveness of entity-specific instructions, leading to informed decisions for further improvements and refinement of the machine-learning model.

FIG. 3C illustrates an example graph of a Gain measure for validating a machine-learning model and an example table that compares the machine-learning model's effectiveness in detecting target entities against conventional methods demonstrating a higher gain in detecting target entities, according to aspects of the disclosure. The prediction system 101 by utilizing the Gain measure to assess the accuracy of the machine-learning model leverages a sophisticated evaluation metric to enhance predictive performance insights. The Gain measure may evaluate how well the machine-learning model improves prediction accuracy over a random baseline by comparing the proportion of true positive cases captured by the machine-learning model to that captured by random selection. This metric may be particularly effective in scenarios with imbalanced datasets or when the cost of false positives and false negatives varies significantly. By calculating the ratio of gains achieved by the model versus those expected by chance, the Gain measure may provide a clear indication of the model's effectiveness in detecting high-value or target instances. The prediction system 101 may integrate the Gain measure into its evaluation framework to offer a more nuanced understanding of the machine-learning model's performance, allowing for targeted improvements and better alignment of predictive capabilities.

In graph 329, the prediction system 101 may utilize the Gain measure to evaluate the effectiveness of the predictive machine-learning model in detecting target entities. The entities may be scored by the machine-learning model, which may estimate the probability of their future poor performance. These probabilities are then sorted into 10 deciles, with each decile representing a segment of entities ordered from highest to lowest risk probability. The top decile may contain entities with the highest predicted risk of poor performance. Determining the Gain may comprise analyzing the lift obtained from each decile, which may reflect the improvements in detecting target entities compared to random selection. By comparing the proportion of true target entities in each decile to what would be expected by chance, the Gain measure may quantify the machine-learning model's effectiveness in targeting target entities.

In one example, table 331 may compare the performance achieved by a technique utilizing one or more machine-learning models 339 (as discussed herein) with the performance achieved by a conventional technique, for example, without using any machine-learning model 337. Without the model, the conventional technique detected 4 poor-performing entities 335 out of 28 targeted entities 333, representing around 14.285% of the total entity population. However, using the machine-learning model, the number of detected poor-performing entities 335 increased to 13, representing around 46.428% of the total entities 333 and capturing 9 additional target entities. In this test set, the machine-learning model successfully demonstrate a gain 341 that is 3.25 times greater than what would be achieved through random selection (e.g., conventional method without model). This improvement reflects a significant enhancement in predictive accuracy and recall, with the model tripling the accuracy and recall in detecting future poor performers and thereby reducing the false negative rate. Once the target entities are detected, the prediction system 101 may determine the underlying reasons behind the entities' target status.

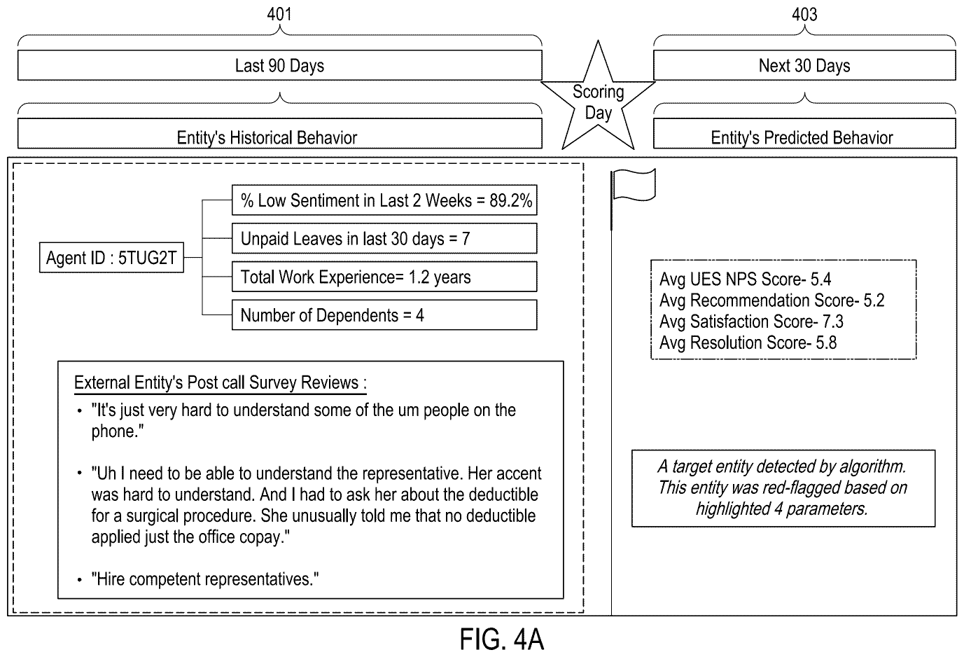

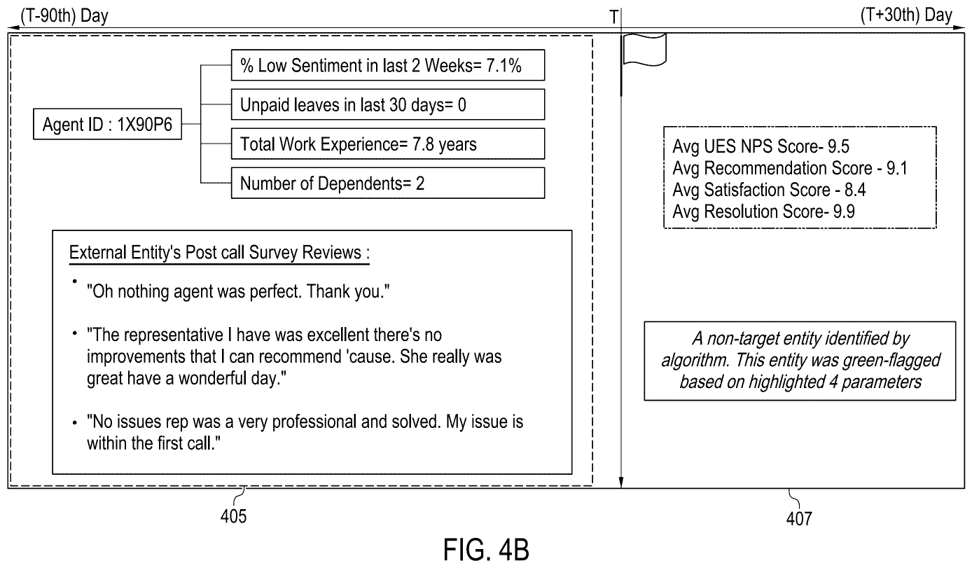

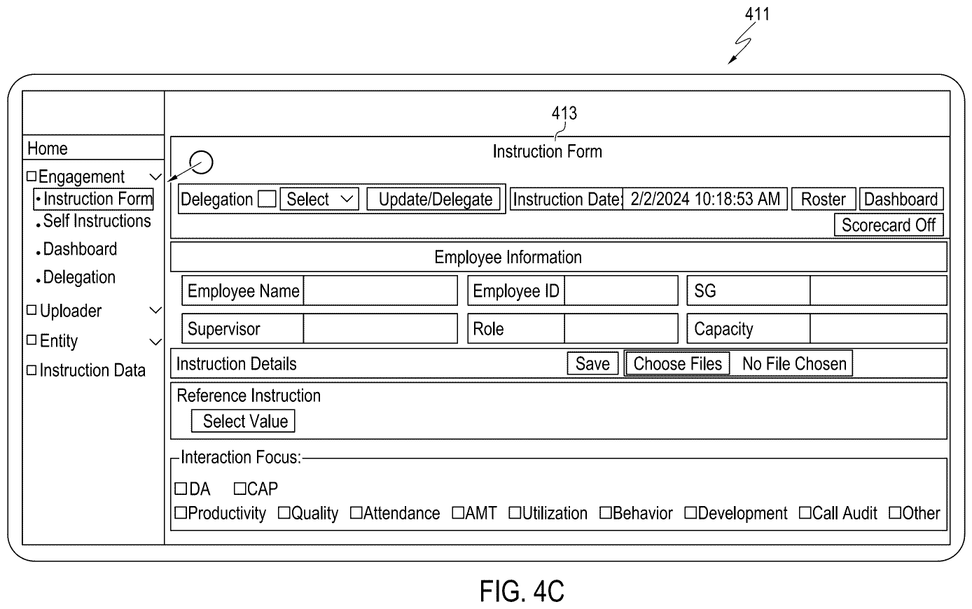

FIG. 4A illustrates example historical entity performance metrics used to generate an entity risk score for an entity ultimately classified by the techniques discussed herein as a target entity and entity performance metrics determined after the entity risk score was generated and verifying that the classification as a target entity was correct, according to aspects of the disclosure. In step 401, the prediction system 101 may process entities' historical behavior during a specific time period (e.g., 90 days). The prediction system 101 may determine one or more of the following for any one or more of the entities:
(i) Percentage of low sentiment in last 2 weeks: This metric may indicate a percentage of calls with negative sentiment over the past two weeks suggesting frequent dissatisfaction or poor communication from the entity. For example, 89.2% of low sentiment in the last 2 weeks may suggest that the entity has frequently encountered issues such as poor communication, unresolved problems, or other factors leading to unhappy external users. Persistent negative sentiment can highlight systemic issues in the entity's approach or service quality, which may require targeted (e.g., entity-specific) instructions and support to address and improve overall external user satisfaction and entity performance.
(ii) Unpaid leaves in the last 30 days: The number of days the entities were absent without pay in the last month. Frequent unpaid leave might reflect issues, such as burnout, health problems, or personal challenges, potentially impacting performance. High rates of unpaid leave might suggest underlying challenges that may impact the entity's ability to perform effectively, and addressing these issues may be crucial for maintaining a stable and high-performing workforce.
(iii) Total work experience: The entities' total duration of employment, might affect their proficiency and handling of calls. For example, 1.2 years may be a relatively short period of experience, and less experienced entities may struggle with complex situations or demonstrate a lower level of efficiency. Limited experience can be correlated with higher risk factors, including a greater likelihood of making mistakes or facing challenges in managing external user interactions effectively. Providing additional training and support might help improve performance and mitigate the risk associated with limited experience.
(iv) Number of dependents: The number of dependents the entities have may influence their stress levels and job performance, potentially affecting their call handling. This additional stress may influence the entity's ability to handle calls effectively and maintain high performance. Understanding and addressing the potential impact of personal circumstances on job performance can be essential for providing appropriate support and ensuring that the entity can manage their responsibilities more efficiently.
(iv) External user post-call survey reviews: Insights into entities' performances from the external user's perspectives. The feedback highlights challenges with communication, such as difficulty in understanding the entity's accent, which may impact external user satisfaction and overall service quality. Such feedback may be crucial for detecting areas where the entity's communication skills may need improvement, directly influencing future performance and external user experience.

In step 403, the prediction system 101 may process entities' predicted behavior during a specific future time period (e.g., the next 30 days) to determine one or more of the following for one or more of the entities:
(i) Average UES NPS score: The average NPS from external users' feedback related to the entities may indicate how likely external users are to recommend the entities based on their experience. For example, a score of 5.4 may suggest that, on average, external users have moderate reservations about recommending the entity, which could imply that their performance is not consistently meeting external user's expectations. This lower score may indicate potential issues in external user's experience or service delivery that need to be addressed to enhance the entity's effectiveness and reputation.
(ii) Average recommendation score: The average score external users give regarding their recommendation of the entity may reflect their overall effectiveness and perceived value. For example, a score of 5.2 may reflect the mean value given by the external users when asked how likely they are to recommend the entity's services to others.
(iii) Average satisfaction score: The average level of external user satisfaction with the entity. This score may represent how pleased external users are with the entity's service, with a higher score indicating better performance and a more positive external user experience.
(iv) Average resolution score: The average score may be related to how well the entities resolve issues, with a higher score reflecting better problem-solving capabilities. A score of 5.8 may indicate that the entity's performance in issue resolution is moderate, suggesting that while they manage to resolve some issues adequately, there may be room for improvement in handling more complex or challenging problems.

In one example, the prediction system 101 may flag (e.g., red flag) at least one entity as target based on the above four scores. In another example, the prediction system 101 may flag at least one entity as target based on the following parameters generated by the machine-learning model:
(i) High percentage of low sentiment calls;
(ii) Feedback from post-call surveys indicating communication issues and competence concerns;
(iii) Historical factors such as high unpaid leave and relatively low experience level; and
(iv) Predicted behavior metrics showing lower scores in key performance areas, suggesting ongoing or potential future issues.

FIG. 4B illustrates an example historical entity performance metrics used to generate an entity risk score for an entity ultimately classified by the techniques discussed herein as a non-target entity and entity performance metrics determined after the entity risk score was generated and verifying that the classification as a non-target entity was correct, according to aspects of the disclosure. Similar to FIG. 4A, in step 405, the prediction system 101 may process entities' historical behavior during a specific time period (e.g., 90 days). The prediction system 101 may determine one or more of the following:
(i) Percentage of low sentiment in last 2 weeks: A 7.1% of low sentiment in the last 2 weeks may indicate a minimal amount of negative sentiment in recent external user interactions, suggesting effective communication and high external user satisfaction.
(ii) Unpaid leaves in the last 30 days: The absence of unpaid leave may indicate strong attendance and reliability, reflecting stability and consistency in the entity's performance.
(iii) Total work experience: The entity's extensive experience of 7.8 years may likely contribute to high proficiency and effective call handling, reducing the likelihood of performance issues.
(iv) Number of dependents: A moderate number of dependents (e.g., 2) may imply manageable personal responsibilities, likely resulting in lower stress levels and stable job performance.
(iv) External user's post-call survey reviews: The post-call survey reviews may highlight the efficiency of the entity during communication, such as ease of understanding the entity and efficiency in resolving the issue, which may impact the external user's satisfaction and overall service quality.

In step 407, the prediction system 101 may process entities' predicted behavior during a specific time period (e.g., the next 30 days) to determine one or more of the following:
(i) Average UES NPS score: A score of 9.5 may indicate that external users are extremely likely to recommend the entities, reflecting exceptional service and external user satisfaction.
(ii) Average recommendation score: A high recommendation score of 9.1 further supports the entity's effectiveness and perceived value in external user interactions.
(iii) Average satisfaction score: A satisfaction score of 8.4 may suggest that external users generally have a positive experience with the entity.
(iv) Average resolution score: The high-resolution score of 9.9 may indicate excellent problem-solving capabilities and successful issue resolution by the entity.

In this example, the prediction system 101 may flag (e.g., green flag) at least one entity as non-target due to consistently positive performance metrics and minimal indicators of potential issues, demonstrating high competence and reliability.

FIG. 4C illustrates an example entity interface diagram generated and/or pre-populated based at least in part on output received from a machine-learning model, according to aspects of the disclosure. The entity interface 411 may include an instruction dashboard that presents various crucial elements to streamline the instruction process. In one example, the instruction dashboard 413 may include one or more of:
(i) Instructions date: This field may allow entities to input or select the specific data when the instruction session is conducted, ensuring proper scheduling and tracking of instruction activities.
(ii) Entity Name: A text field where the name of the entity being instructed may be entered, facilitating easy identification.
(iii) Entity ID: A unique identifier of the entity, which may ensure that the instruction data is accurately linked to the correct individual.
(iv) Service Grade (SG): This field indicates the entity's service grade or level within the organization, which may influence the focus and depth of the instructions.
(v) Supervisor: The name and ID of the supervisor responsible for the instruction session, allowing for accountability and follow-up.
(vi) Role: The entity's role or position within the company, providing context for the instruction session.
(vii) Capacity: This may refer to the current work capacity or load of the entity, which may affect their performance and thus the focus of the instruction session.

The instruction dashboard 413 may also include an instruction detail section that may provide a structured area for entering specific information related to the instruction session, this may include:
(viii) Save options: Entities may save the instruction details either as a draft for later completion or finalize and submit the session records.
(ix) Choose file: This option may allow entities to upload relevant documents or files related to the instruction session, such as performance reports or feedback forms.

The instruction dashboard 413 may also include a reference instruction portion, where entities may select a reference instruction value to align the current session with previous instruction examples or standards. This may facilitate in maintaining consistency and leveraging best practices.

The instruction dashboard 413 may further include an interaction focus section that may allow entities to select various focus areas for the instruction session. The available options may include one or more of:
(x) Development Areas (DA): Specific areas for professional growth and skill enhancement.
(xi) Corrective Action Plan (CAP): Focus on areas requiring corrective measures to address performance gaps.
(xii) Productivity: Metrics related to the efficiency and output of the entity.
(xiii) Quality: Standards and benchmarks for the quality of work or service provided.
(xiv) Attendance: Records and concerns related to the entity's attendance and punctuality.
(xv) Average Handle Time (AHT): The average time taken to handle an external user interaction, pertinent to roles in external user service or support.
(xvi) Utilization: Measurement of how effectively the entity's time is used in their role.
(xvii) Behavior: Assessment of the entity's behavior and interaction style.
(xviii) Development: Focus on career development and skill advancement.
(xix) Call Audit: Evaluation of recorded calls to assess performance and adherence to guidelines.
(xx) Other: Any additional focus areas that do not fit into the predefined categories but are relevant to the instruction session.

In one instance, the entity interface 411 may be pre-populated based on outputs from the machine-learning model's analysis of the entity's performance data. For example, the machine-learning model may identify that the productivity of the entity is consistently low, whereupon the instruction dashboard 413 may populate the instruction details section with specific instructions for the entity, such as enrolling in time management training or scheduling short breaks to maintain focus. Additionally, a productivity checkbox in the interaction focus section of the instruction dashboard 413 may be pre-checked to indicate that the machine-learning model has identified this as a key focus area. Furthermore, the entity interface 411 may generate a display of a button to instantaneously update the entity computing device 123 regarding the specific instructions.

This detailed and interactive entity interface 411 may ensure that instruction sessions are comprehensive, well-documented, and tailored to address specific areas of performance and development, and may enhance overall entity management and improvement.

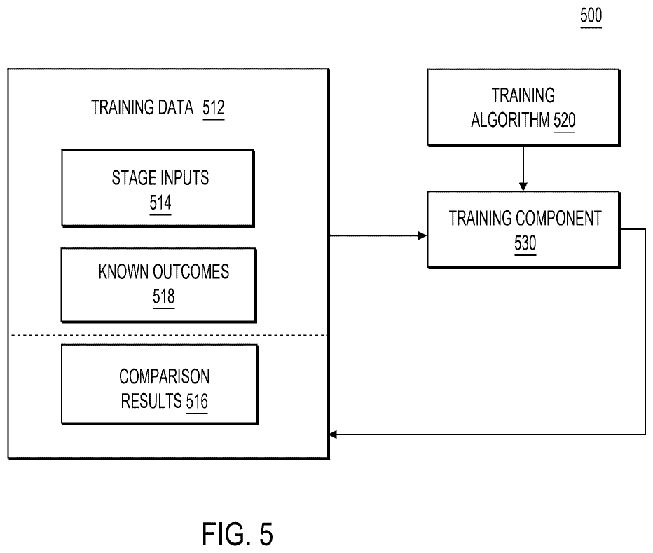

One or more implementations disclosed herein include and/or may be implemented using a machine-learning model. For example, one or more of the components of the prediction system 101 may be implemented using a machine-learning model and/or may be used to train the machine-learning model. A given machine-learning model may be trained using the training flow chart 500 of FIG. 5. Training data 512 may include one or more of stage inputs 514 and known outcomes 518 related to the machine-learning model to be trained. Stage inputs 514 may be from any applicable source including text, visual representations, files, data, values, comparisons, and stage outputs, e.g., one or more outputs from one or more steps from FIG. 2. The known outcomes 518 may be included for the machine-learning models generated based on supervised or semi-supervised training. An unsupervised machine-learning model may not be trained using known outcomes 518. Known outcomes 518 may include known or desired outputs for future inputs similar to or in the same category as stage inputs 514 that do not have corresponding known outputs.

The training data 512 and a training algorithm 520, e.g., one or more of the components implemented using the machine-learning model and/or may be used to train the machine-learning model, may be provided to a training component 530 that may apply the training data 512 to the training algorithm 520 to generate the machine-learning model. According to an implementation, the training component 530 may be provided comparison results 516 that compare a previous output of the corresponding machine-learning model to apply the previous result to re-train the machine-learning model. The comparison results 516 may be used by training component 530 to update the corresponding machine-learning model. The training algorithm 520 may employ techniques suitable for machine-learning framework, utilizing model architectures including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, classifiers such as K-Nearest Neighbors, and/or discriminative models such as Decision Forests and maximum margin methods, the models specifically discussed herein, or the like.

The machine-learning model used herein may be trained and/or used by adjusting one or more parameters of the machine-learning model. For example, during training, a given weight may be adjusted (e.g., increased, decreased, removed) based on training data or input data. Similarly, a layer may be updated, added, or removed based on training data/and or input data. The resulting outputs may be adjusted based on the adjusted weights and/or layers.

In general, any process or operation discussed in this disclosure is understood to be computer-implementable, such as the processes illustrated in FIG. 2 may be performed by one or more processors of a computer system as described herein. A process or process step performed by one or more processors may also referred to as an operation. The one or more processors may be configured to perform such processes by having access to instructions (e.g., software or computer-readable code) that, when executed by one or more processors, cause one or more processors to perform the processes. The instructions may be stored in a memory of the computer system. A processor may comprise a central processing unit (CPU), a graphics processing unit (GPU), or any suitable type of processing unit.

A computer system, such as a system or device implementing a process or operation in the examples above, may include one or more computing devices. One or more processors of a computer system may be included in a single computing device or distributed among a plurality of computing devices. One or more processors of a computer system may be connected to a data storage device. A memory of the computer system may include the respective memory of each computing device of the plurality of computing devices.

FIG. 6 illustrates an implementation of a computer system that may execute techniques presented herein. The computer system 600 can include a set of instructions that can be executed to cause the computer system 600 to perform any one or more of the methods or computer based functions disclosed herein. The computer system 600 may operate as a standalone device or may be connected, e.g., using a network, to other computer systems or peripheral devices.

Unless specifically stated otherwise, as apparent from the following discussions, it is appreciated that throughout the specification, discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer,” a “computing machine,” a “computing platform,” a “computing device,” or a “server” may include one or more processors.

In a networked deployment, the computer system 600 may operate in the capacity of a server or as a client entity computer in a server-client entity network environment, or as a peer computer system in a peer-to-peer (or distributed) network environment. The computer system 600 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the computer system 600 may be implemented using electronic devices that provide voice, video, or data communication. Further, while the computer system 600 is illustrated as a single system, the term “system” shall also be taken to include any collection of systems or sub-systems that individually or jointly execute a set, or multiple sets, of instructions to perform one or more computer functions.

As illustrated in FIG. 6, the computer system 600 may include a processor 602, e.g., a central processing unit (CPU), a graphics processing unit (GPU), or both. The processor 602 may comprise one or more processors, digital signal processors, application specific integrated circuits, field programmable gate arrays, servers, networks, digital circuits, analog circuits, combinations thereof, or other now known or later developed devices for analyzing and processing data. The processor 602 may execute processor-executable instructions, such as firmware, a software program, a machine-learned model, etc.

The computer system 600 may include a memory 604 that can communicate via bus 608. Memory 604 may comprise a main memory, a static memory, and/or a dynamic memory. Memory 604 may include, but is not limited to, non-transitory computer-readable storage media such as volatile and/or non-volatile memory, including but not limited to random access memory, read-only memory, programmable read-only memory, electrically programmable read-only memory, electrically erasable read-only memory, flash memory, magnetic tape or disk, optical media, and/or the like. In one implementation, the memory 604 may include a cache or random-access memory for the processor 602. In alternative implementations, the memory 604 is separate from the processor 602, such as a cache memory of a processor, the system memory, or other memory. Memory 604 may comprise an external storage device or database for storing data. Examples include a hard drive, compact disc (“CD”), digital video disc (“DVD”), memory card, memory stick, floppy disc, universal serial bus (“USB”) memory device, or any other device operative to store data. The memory 604 is operable to store instructions executable by the processor 602. The functions, acts, or tasks illustrated in the figures or described herein may be performed by processor 602 executing the instructions stored in memory 604. The functions, acts, or tasks are independent of the particular type of instruction set, storage media, processor, or processing strategy and may be performed by software, hardware, integrated circuits, firmware, micro-code, and the like, operating alone or in combination. Likewise, processing strategies may include multiprocessing, multitasking, parallel processing, and the like.

As shown, the computer system 600 may additionally or alternatively include one or more input/output devices, such as a display 610 (e.g., a liquid crystal display (LCD), an organic light emitting diode (OLED), a flat panel display, a solid-state display, a cathode ray tube (CRT), a projector, a printer or other now known or later developed display device for outputting determined information).

Additionally or alternatively, the computer system 600 may include an input/output device 612 configured to allow an entity to interact with any of the components of the computer system 600. The input/output device 612 may be a number pad, a keyboard, a cursor control device, such as a mouse, a joystick, haptic input and/or output device, touch screen display, remote control, microphone, speaker, or any other device operative to interact with the computer system 600.

The communication port or interface 620 may comprise software and/or hardware connection(s), protocol(s), and/or the like. The communication port or interface 620 may be configured to connect with the network 630, external media, display 610, or any other components in the computer system 600, or combinations thereof. The connection with network 630 may be established via a physical connection, such as a wired Ethernet connection, or may be established wirelessly. Likewise, the additional connections with other components of the computer system 600 may be physical connections or may be established wirelessly.

In an alternative implementation, dedicated hardware implementations, such as application specific integrated circuits, programmable logic arrays, and other hardware devices, is constructed to implement one or more of the methods described herein. Applications that may include the apparatus and systems of various implementations broadly include a variety of electronic and computer systems. One or more implementations described herein may implement functions using two or more specific interconnected hardware components or devices with related control and data signals that are communicated between and through the components, or as portions of an application-specific integrated circuit. Accordingly, the present system encompasses software, firmware, and hardware implementations.

Computer system 600 may be connected to network 630. Network 630 may define one or more networks including wired or wireless networks. The wireless network may be a cellular telephone network, an 802.10, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. Network 630 may include wide area networks (WAN), such as the Internet, local area networks (LAN), campus area networks, metropolitan area networks, a direct connection such as through a Universal Serial Bus (USB) port, or any other networks that may allow for data communication. Network 630 may be configured to couple one computing device to another computing device to enable communication of data between the devices. Network 630 may generally enabled to employ any form of machine-readable media for communicating information from one device to another. Network 630 may include communication methods by which information travels between computing devices. Network 630 may be divided into sub-networks. The sub-networks may allow access to all of the other components connected thereto or the sub-networks may restrict access between the components. Network 630 may be regarded as a public or private network connection and may include, for example, a virtual private network or an encryption or other security mechanism employed over the public Internet, or the like.

### EXAMPLES

The present disclosure furthermore relates to the following aspects.
Example 1. A computer-implemented method comprising: receiving, by one or more processors, multi-dimensional data that includes (1) a first value of a first dimension indicative of a comparison of an entity relative to a group of entities, and (2) a second value of a second dimension indicative of an attribute of the entity irrespective of the group of entities; inputting, by the one or more processors, the multi-dimensional data to a first machine-learning model, causing the first machine-learning model to output a prediction value determined based at least in part on applying a first weight to the first value and a second weight to the second value; and in response to determining that the prediction value satisfies a first threshold value associated with an adverse event: filtering, by the one or more processors, historical text data associated with the entity to exclude a subset of data that satisfies a second threshold value associated with acceptable operations; and generating, by the one or more processors and by inputting the filtered historical text data into a second machine-learning model, a sequence of words to produce a transcript of a recommended action to prevent a future occurrence of the adverse event for the entity.
Example 2. The computer-implemented method of example 1, wherein the first dimension includes a performance-related variable that indicates a quantitative measure of a past performance of the entity.
Example 3. The computer-implemented method of example 2, wherein the performance-related variable of the entity is received responsive to transmitting a query to one or more external users' computing devices upon detecting completion of an interaction between a first computing device associated with the entity and the one or more external users' computing devices; and the performance-related variable comprises a change in at least one or more of: a net promoter score (NPS), a recommendation score, a resolution score, a satisfaction score, or a user experience score (UES).
Example 4. The computer-implemented method of any of examples 1-3, wherein the second dimension includes a behavioral variable that indicates a quantitative or qualitative measure of at least one of an interaction style, an engagement level, or a workplace profile associated with the entity.
Example 5. The computer-implemented method of example 4, wherein the behavioral variable of the entity includes at least one or more of: occupancy data, inventory data, temporal data associated with non-productive activities, workplace profile data, natural language processing (NLP) based features, entity-centric features, or call-audit based features.
Example 6. The computer-implemented method of any of examples 1-5, wherein training the first machine-learning model comprises: receiving a training dataset associated with a set of sample entities, wherein the training dataset comprises a set of performance-related training variables and behavioral training variables; associating a first classification with a first sample entity of the set of sample entities based on a subset of the training dataset associated with the first sample entity; and determining, by the first machine-learning model and based at least in part on a subset of the set of performance-related training variables and the behavioral training variables associated with the first sample entity, an estimated value; determining that the estimated value satisfies the first threshold value, indicating that the first sample entity is associated with a second classification; determining, based at least in part on a first difference between the second classification and the first classification or a second difference between the estimated value and a value associated with the first classification, a loss; and modifying one or more parameters of the first machine-learning model to reduce the loss.
Example 7. The computer-implemented method of any of examples 1-6, wherein the first threshold value reflects at least one or more of: (i) a rank indicating that the entity is in a top percentile among the group of entities based on the prediction value, or (ii) a probability indicating a level of confidence that the entity requires investigation, wherein a higher prediction value corresponds to a higher probability of triggering the investigation.
Example 8. The computer-implemented method of any of examples 1-7, further comprising: determining, by the one or more processors, a performance of the first machine-learning model utilizing a gain/lift measure, wherein the gain/lift measure quantifies accuracy of the first machine-learning model by: sorting a plurality of entities, which the first machine-learning model has classified, into one or more deciles based on respective classifications; and determining a lift for a first decile by determining a difference between (i) a first ratio of the entity in the first decile and classified by the first machine-learning model as a target entity by determining the predictive value satisfied the first threshold value to a total number of entities in the first decile, and (ii) a total number of target entities classified by a rule-based method to a total number of entities.
Example 9. The computer-implemented method of example 8, wherein a top decile of the one or more deciles includes entities with highest-risk probabilities, a middle decile of the one or more deciles includes entities with moderate-risk probabilities, and a lower decile of the one or more deciles includes entities with lowest-risk probabilities.
Example 10. The computer-implemented method of any of examples 1-9, further comprising: tracking, by the one or more processors, adherence to the recommended action by the entity, wherein one or more actions performed by the entity are monitored to verify completion of the recommended action; and comparing, by the one or more processors, performance metrics upon completion of the recommended action and a pre-determined performance threshold to quantify improvement or deviation.
Example 11. The computer-implemented method of any of examples 1-10, wherein the first machine-learning model comprises a set of decision trees.
Example 12. The computer-implemented method of any of examples 1-11, wherein the second value is inputted into the second machine-learning model, and wherein the second machine-learning model comprises at least one of a generative adversarial network, a variational autoencoder, a recurrent neural network, a transformer-based model, or a reinforcement learning model.
Example 13. A system comprising: one or more processors; and one or more non-transitory computer readable media storing instructions which, when executed by the one or more processors, cause the one or more processors to: receive multi-dimensional data that includes (1) a first value of a first dimension indicative of a comparison of an entity relative to a group of entities, and (2) a second value of a second dimension indicative of an attribute of the entity irrespective of the group of entities; input the multi-dimensional data to a first machine-learning model, causing the first machine-learning model to output a prediction value determined based at least in part on applying a first weight to the first value and a second weight to the second value; and in response to determining that the prediction value satisfies a first threshold value associated with an adverse event: filter, by the one or more processors, historical text data associated with the entity to exclude a subset of data that satisfies a second threshold value associated with acceptable operations; and generate, by inputting the filtered historical text data into a second machine-learning model, a sequence of words to produce a transcript of a recommended action to prevent a future occurrence of the adverse event for the entity.
Example 14. The system of example 13, wherein the first dimension includes a performance-related variable that indicates a quantitative measure of a past performance of the entity.
Example 15. The system of example 14, wherein the performance-related variable of the entity is received responsive to transmitting a query to one or more external users' computing devices upon detecting completion of an interaction between a first computing device associated with the entity and the one or more external users' computing devices; and the performance-related variable comprises a change in at least one or more of: a net promoter score (NPS), a recommendation score, a resolution score, a satisfaction score, or a user experience score (UES).
Example 16. The system of any of examples 13-15, wherein the second dimension includes a behavioral variable that indicates a quantitative or qualitative measure of at least one or more of an interaction style, an engagement level, or a workplace profile associated with the entity.
Example 17. The system of example 16, wherein the behavioral variable of the entity includes at least one or more of: occupancy data, inventory data, temporal data associated with non-productive activities, workplace profile data, natural language processing (NLP) based features, entity-centric features, or call-audit based features.
Example 18. The system of any of examples 13-17, wherein training the first machine-learning model comprises the one or more processors to: receive a training dataset associated with a set of sample entities, wherein the training dataset comprises a set of performance-related training variables and behavioral training variables; associate a first classification with a first sample entity of the set of sample entities based on a subset of the training dataset associated with the first sample entity; determine, by the first machine-learning model and based at least in part on a subset of the set of performance-related training variables and the behavioral training variables associated with the first sample entity, an estimated value; determine that the estimated value satisfies the first threshold value, indicating that the first sample entity is associated with a second classification; determine, based at least in part on a first difference between the second classification and the first classification or a second difference between the estimated value and a value associated with the first classification, a loss; and modify one or more parameters of the first machine-learning model to reduce the loss.
Example 19. One or more non-transitory computer-readable media storing processor-executable instructions that, when executed by one or more processors of a computing system, cause the one or more processors to perform operations comprising: receiving multi-dimensional data that includes (1) a first value of a first dimension indicative of a comparison of an entity relative to a group of entities, and (2) a second value of a second dimension indicative of an attribute of the entity irrespective of the group of entities; inputting the multi-dimensional data to a first machine-learning model, causing the first machine-learning model to output a prediction value determined based at least in part on applying a first weight to the first value and a second weight to the second value; and in response to determining that the prediction value satisfies a first threshold value associated with an adverse event: filtering historical text data associated with the entity to exclude a subset of data that satisfies a second threshold value associated with acceptable operations; and generating, by inputting the filtered historical text data into a second machine-learning model, a sequence of words to produce a transcript of a recommended action to prevent a future occurrence of the adverse event for the entity.
Example 20. The one or more non-transitory computer-readable media of example 19, wherein the first dimension includes a performance-related variable that indicates a quantitative measure of a past performance of the entity, and wherein the second dimension includes a behavioral variable that indicates a quantitative or qualitative measure of at least one or more of an interaction style, an engagement level, or a workplace profile associated with the entity.

### CONCLUSION

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware components of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible component, be that a component that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components include a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These include physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” or the like means that a particular element, feature, structure, or characteristic described in connection with the embodiment is included in at least one embodiment, but not every embodiment necessarily includes the particular element, feature, structure, or characteristic. Different instances of the phrase “in one embodiment” in various places in the specification do not necessarily all refer to the same embodiment, although they may in some cases.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and can be a null set (i.e., a set containing zero elements) or may comprise one, two, or more elements. A “subset” is intended to mean a collection of elements that are all elements of a set, but that does not include other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” component refers to one or more of that component. As such, the terms “a” or “an”, “one or more”, and “at least one” can be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine-learning model,” “machine-learned component”, “artificial intelligence”, “artificial intelligence component”), or species thereof (e.g., “a large language model”, “a neural network”) may include a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters (e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may include a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may include any type of model configured, trained, and/or the like to generate a prediction output for a model input. In some examples, any of the logic, component(s), routines, and/or the like discussed herein may be implemented as a machine-learned model.

The machine-learned model may include one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112 (f) unless traditional means-plus-function language is expressly recited, such as “means for” or “step for” language being explicitly recited in the claim(s).

What is claimed is:

1. A computer-implemented method comprising:
receiving, by one or more processors, multi-dimensional data that includes (1) a first value of a first dimension indicative of a comparison of an entity relative to a group of entities, and (2) a second value of a second dimension indicative of an attribute of the entity irrespective of the group of entities;
inputting, by the one or more processors, the multi-dimensional data to a first machine-learning model, causing the first machine-learning model to output a prediction value determined based at least in part on applying a first weight to the first value and a second weight to the second value; and
in response to determining that the prediction value satisfies a first threshold value associated with an adverse event:
filtering, by the one or more processors, historical text data associated with the entity to exclude a subset of data that satisfies a second threshold value associated with acceptable operations; and
generating, by the one or more processors and by inputting the filtered historical text data into a second machine-learning model, a sequence of words to produce a transcript of a recommended action to prevent a future occurrence of the adverse event for the entity.

2. The computer-implemented method of claim 1, wherein the first dimension includes a performance-related variable that indicates a quantitative measure of a past performance of the entity.

3. The computer-implemented method of claim 2, wherein:
the performance-related variable of the entity is received responsive to transmitting a query to one or more external users' computing devices upon detecting completion of an interaction between a first computing device associated with the entity and the one or more external users' computing devices; and
the performance-related variable comprises a change in at least one or more of:
a net promoter score (NPS),
a recommendation score,
a resolution score,
a satisfaction score, or
a user experience score (UES).

4. The computer-implemented method of claim 1, wherein the second dimension includes a behavioral variable that indicates a quantitative or qualitative measure of at least one of an interaction style, an engagement level, or a workplace profile associated with the entity.

5. The computer-implemented method of claim 4, wherein the behavioral variable of the entity includes at least one or more of:
occupancy data,
inventory data,
temporal data associated with non-productive activities,
workplace profile data,
natural language processing (NLP) based features,
entity-centric features, or
call-audit based features.

6. The computer-implemented method of claim 1, wherein training the first machine-learning model comprises:
receiving a training dataset associated with a set of sample entities, wherein the training dataset comprises a set of performance-related training variables and behavioral training variables;
associating a first classification with a first sample entity of the set of sample entities based on a subset of the training dataset associated with the first sample entity; and
determining, by the first machine-learning model and based at least in part on a subset of the set of performance-related training variables and the behavioral training variables associated with the first sample entity, an estimated value;
determining that the estimated value satisfies the first threshold value, indicating that the first sample entity is associated with a second classification;
determining, based at least in part on a first difference between the second classification and the first classification or a second difference between the estimated value and a value associated with the first classification, a loss; and
modifying one or more parameters of the first machine-learning model to reduce the loss.

7. The computer-implemented method of claim 1, wherein the first threshold value reflects at least one or more of:
(i) a rank indicating that the entity is in a top percentile among the group of entities based on the prediction value, or
(ii) a probability indicating a level of confidence that the entity requires investigation, wherein a higher prediction value corresponds to a higher probability of triggering the investigation.

8. The computer-implemented method of claim 1, further comprising:
determining, by the one or more processors, a performance of the first machine-learning model utilizing a gain/lift measure, wherein the gain/lift measure quantifies accuracy of the first machine-learning model by:
sorting a plurality of entities, which the first machine-learning model has classified, into one or more deciles based on respective classifications; and
determining a lift for a first decile by determining a difference between (i) a first ratio of the entity in the first decile and classified by the first machine-learning model as a target entity by determining the predictive value satisfied the first threshold value to a total number of entities in the first decile, and (ii) a total number of target entities classified by a rule-based method to a total number of entities.

9. The computer-implemented method of claim 8, wherein a top decile of the one or more deciles includes entities with highest-risk probabilities, a middle decile of the one or more deciles includes entities with moderate-risk probabilities, and a lower decile of the one or more deciles includes entities with lowest-risk probabilities.

10. The computer-implemented method of claim 1, further comprising:
tracking, by the one or more processors, adherence to the recommended action by the entity, wherein one or more actions performed by the entity are monitored to verify completion of the recommended action; and
comparing, by the one or more processors, performance metrics upon completion of the recommended action and a pre-determined performance threshold to quantify improvement or deviation.

11. The computer-implemented method of claim 1, wherein the first machine-learning model comprises a set of decision trees.

12. The computer-implemented method of claim 1, wherein the second value is inputted into the second machine-learning model, and wherein the second machine-learning model comprises at least one of a generative adversarial network, a variational autoencoder, a recurrent neural network, a transformer-based model, or a reinforcement learning model.

13. A system comprising:
one or more processors; and
one or more non-transitory computer readable media storing instructions which, when executed by the one or more processors, cause the one or more processors to:
receive multi-dimensional data that includes (1) a first value of a first dimension indicative of a comparison of an entity relative to a group of entities, and (2) a second value of a second dimension indicative of an attribute of the entity irrespective of the group of entities;
input the multi-dimensional data to a first machine-learning model, causing the first machine-learning model to output a prediction value determined based at least in part on applying a first weight to the first value and a second weight to the second value; and
in response to determining that the prediction value satisfies a first threshold value associated with an adverse event:
filter, by the one or more processors, historical text data associated with the entity to exclude a subset of data that satisfies a second threshold value associated with acceptable operations; and
generate, by inputting the filtered historical text data into a second machine-learning model, a sequence of words to produce a transcript of a recommended action to prevent a future occurrence of the adverse event for the entity.

14. The system of claim 13, wherein the first dimension includes a performance-related variable that indicates a quantitative measure of a past performance of the entity.

15. The system of claim 14, wherein:
the performance-related variable of the entity is received responsive to transmitting a query to one or more external users' computing devices upon detecting completion of an interaction between a first computing device associated with the entity and the one or more external users' computing devices; and
the performance-related variable comprises a change in at least one or more of:
a net promoter score (NPS),
a recommendation score,
a resolution score,
a satisfaction score, or
a user experience score (UES).

16. The system of claim 13, wherein the second dimension includes a behavioral variable that indicates a quantitative or qualitative measure of at least one or more of an interaction style, an engagement level, or a workplace profile associated with the entity.

17. The system of claim 16, wherein the behavioral variable of the entity includes at least one or more of:
occupancy data,
inventory data,
temporal data associated with non-productive activities,
workplace profile data,
natural language processing (NLP) based features,
entity-centric features, or
call-audit based features.

18. The system of claim 13, wherein training the first machine-learning model comprises the one or more processors to:
receive a training dataset associated with a set of sample entities, wherein the training dataset comprises a set of performance-related training variables and behavioral training variables;
associate a first classification with a first sample entity of the set of sample entities based on a subset of the training dataset associated with the first sample entity;
determine, by the first machine-learning model and based at least in part on a subset of the set of performance-related training variables and the behavioral training variables associated with the first sample entity, an estimated value;
determine that the estimated value satisfies the first threshold value, indicating that the first sample entity is associated with a second classification;
determine, based at least in part on a first difference between the second classification and the first classification or a second difference between the estimated value and a value associated with the first classification, a loss; and
modify one or more parameters of the first machine-learning model to reduce the loss.

19. One or more non-transitory computer-readable media storing processor-executable instructions which, when executed by one or more processors of a computing system, cause the one or more processors to perform operations comprising:
receiving multi-dimensional data that includes (1) a first value of a first dimension indicative of a comparison of an entity relative to a group of entities, and (2) a second value of a second dimension indicative of an attribute of the entity irrespective of the group of entities;
inputting the multi-dimensional data to a first machine-learning model, causing the first machine-learning model to output a prediction value determined based at least in part on applying a first weight to the first value and a second weight to the second value; and
in response to determining that the prediction value satisfies a first threshold value associated with an adverse event:
filtering historical text data associated with the entity to exclude a subset of data that satisfies a second threshold value associated with acceptable operations; and
generating, by inputting the filtered historical text data into a second machine-learning model, a sequence of words to produce a transcript of a recommended action to prevent a future occurrence of the adverse event for the entity.

20. The one or more non-transitory computer-readable media of claim 19, wherein the first dimension includes a performance-related variable that indicates a quantitative measure of a past performance of the entity, and wherein the second dimension includes a behavioral variable that indicates a quantitative or qualitative measure of at least one or more of an interaction style, an engagement level, or a workplace profile associated with the entity.
